(19) United States
(12) Patent Application Publication
(10) Pub. No.: US 2013/0071318 A1
(43) Pub. Date: Mar. 21, 2013

(54) FUEL REFORMER, SELECTIVE CO METHANATION METHOD, SELECTIVE CO METHANATION CATALYST, AND PROCESS FOR PRODUCING THE SAME

(71) Applicant: University of Yamanashi, Kofu-shi (JP)

(72) Inventors: Kazutoshi HIGASHIYAMA, Kofu-shi (JP); Toshihiro MIYAO, Kofu-shi (JP); Masahiro WATANABE, Kofu-shi (JP); Hisao YAMASHITA, Kofu-shi (JP); Kiyoshi YAGI, Matsuyama-shi (JP); Aihua CHEN, Beijing (CN)

(73) Assignee: UNIVERSITY OF YAMANASHI, Kofu-shi (JP)

(21) Appl. No.: 13/675,410

(22) Filed: Nov. 13, 2012

Related U.S. Application Data
(63) Continuation of application No. PCT/JP2011/061468, filed on May 12, 2011.

(30) Foreign Application Priority Data
May 13, 2010 (JP) 2010-111530

(51) Int. Cl. B01J 27/24; C10K 1/20; C10K 1/22

(52) U.S. Cl. CPC B01J 27/24; C10K 1/22; C10K 1/20
USPC 423/648.1; 422/129; 502/224; 502/300; 502/229; 502/230; 502/337; 502/325; 502/339; 502/231; 502/355; 502/227; 502/350; 502/240; 502/349; 502/304; 502/100

(57) ABSTRACT

Provided is a catalyst for fuel reformation that causes carbon monoxide contained in hydrogen gas, which is produced from a variety of hydrocarbon fuels, to react with hydrogen and thereby to be transformed into methane, while inhibiting methanation of carbon dioxide contained in the hydrogen gas. The selective CO methanation catalyst includes at least one of a halogen, an inorganic acid, and a metal oxo-acid adsorbed or bonded as a carbon dioxide reaction inhibitor to a carbon monoxide methanation active component.

### BACKGROUND OF THE INVENTION

1. Field of the Invention

The present invention relates to a fuel reformer for producing hydrogen gas from a variety of hydrocarbon fuels such as natural gas, LPG, and kerosene, a method for selectively transforming carbon monoxide (hereinafter referred to as “CO”), which is produced along with carbon dioxide (hereinafter referred to as “CO₂”) as gas byproduct during fuel reformation, into methane (hereinafter referred to as “CH₄”), a catalyst for use in such a method, and a process for producing such a catalyst.

2. Description of the Related Art

Since polymer electrolyte fuel cells operate at low temperature of around 80 degrees C., if hydrogen rich gas serving as fuel contains CO at a certain level or higher, the anode platinum catalyst undergoes CO poisoning, suffering from a problem of reduction in the power generation capacity and finally making power generation impossible.

In order to avoid CO poisoning, in home-use polymer electrolyte fuel cell power generation systems using hydrogen rich gas transformed from utility gas, LP gas, kerosene, or the like by a fuel reformer, it is desirable to keep the CO concentration of gas incoming into the anode of the fuel cell constantly at 10 ppm or less. Many actual systems, in which produced gas is mixed with air in the final stage of the fuel reformation process, employ a selective CO oxidation catalyst for oxidizing CO contained in the gas to CO₂.

CO+½O₂═CO₂ (Reaction Formula 1)

This type of catalyst requires external air to be taken in constantly as indicated by Reaction Formula 1. It is therefore necessary to install in the fuel reformer an air blower, a control system therefor, and further a complex structure for mixing supplied air and reaction gas homogeneously.

Selective CO methanation catalysts have recently been attracting attention as an alternative for selective CO oxidation catalysts. For example, Japanese Patent Application Laid-open Publication Nos. Hei 3-93602 and 2007-252988 disclose some selective CO methanation catalysts. Further, Japanese Patent No. 3865479 discloses combining a selective CO oxidation catalyst with a selective CO methanation catalyst.

As indicated by Reaction Formula 2, since selective CO methanation catalysts cause CO to react with H₂ to produce CH₄, which is harmless to platinum electrode catalysts, there is no need to supply air externally.

CO+3H₂═CH₄+H₂O (Reaction Formula 2)

However, as indicated by Reaction Formula 3, CO methanation reaction involves CO₂ methanation reaction as a side reaction. Since CO₂ exists at a concentration higher than that of CO, CO₂ methanation reaction would consume large amounts of hydrogen and, as an exothermic reaction, might further lead to thermal runaway.

CO₂+4H₂═CH₄+2H₂O (Reaction Formula 3)

Therefore, selective CO methanation catalysts are required to have a high CO methanation activity but a low CO₂ methanation activity (i.e. have a high CO selectivity). In addition, a reverse water-gas-shift reaction as indicated by Reaction Formula 4, in which CO₂ reacts with H₂ to produce CO, is unignorable at high temperature and required to be suppressed (inhibited).

CO₂+2H₂═CO+2H₂O (Reaction Formula 4)

Several studies on selective CO methanation catalysts have been released including Applied Catalysis A, 326 (2007) 213-218 (Robert A. Dagle et al.), Catalyst, 51 (2009) 135-137 (Toshihiro Miyao et al.), and Proceedings of the 105th Catalyst Debates, No. 1 P29, Kyoto, 2010.3/24-25 (Kohei Urasaki et al.). These studies report that selective CO methanation catalysts Ru/Al₂O₃, Ru/NiAl₂O₄, and Ni/TiO₂ have a high methanation activity and, at the same time, a high CO/CO₂ selectivity.

Proceedings of the 104th Catalyst Debates, No. 4 F06, Miyazaki, 2009.9/27-30 (Shingo Komori et al.) report that a 1 wt % Ru/Ni—Al-based oxide selective CO methanation catalyst underwent a performance evaluation test with a 1 kW fuel reformer in a production size and showed a consistent performance for six hours.

There is a need for a novel catalyst that transforms CO contained in hydrogen gas, which is produced from a variety of hydrocarbon fuels such as natural gas, LPG, and kerosene, into CH₄, while suppressing the level of CO₂ methanation reaction as low as possible, and further promises a longer life. This is because the incoming concentration of coexisting CO₂ is nearly ten times as high as that of CO and it is therefore necessary for the CO₂ methanation reaction and reverse water-gas-shift reaction to be maintained at sufficiently low level even during a long period of operation.

### SUMMARY OF THE INVENTION

The present invention provides a novel catalyst for selectively transforming carbon monoxide into methane while selectively inhibiting (suppressing) carbon dioxide methanation reaction, and a process for producing such a catalyst.

The present invention also provides a selective CO methanation method using such a catalyst, and a fuel reformer utilizing such a catalyst.

The present invention is directed to a catalyst for selectively transforming carbon monoxide in hydrogen gas containing carbon monoxide and carbon dioxide into methane, including an oxide support with at least one of a noble metal and a transition metal supported thereon as an active component, and at least one of a halogen, an inorganic acid, and a metal oxo-acid adsorbed or bonded thereto as a carbon dioxide methanation reaction inhibitor (suppressor).

That is, the present invention is based on the finding that the catalytic rate in hydrogen gas refining reaction can be increased and reduced, and provides a catalyst with a substance added thereto that cannot affect carbon monoxide methanation reaction but can selectively inhibit (suppress) carbon dioxide methanation reaction only.

The thus arranged catalyst is expected to contribute to the following reaction mechanism.

(1) The catalyst includes at least one of a halogen, an inorganic acid, and a metal oxo-acid adsorbed or bonded thereto as a carbon dioxide methanation reaction inhibitor (suppressor). The inhibitor (suppressor) is adsorbed to, bonded to, or combines with the surface of the active component as well as the interface between the active component and the support, the surface of the support in the vicinity, and also the inside of the active component and the support to positively charge (δ+) the surface of active metal particles with its strong electron-withdrawing effect. This makes gas-phase carbon dioxide (hereinafter referred to as “CO₂ (g)”) less likely to be adsorbed onto the surface of the active metal particles. The more the surface of the active metal is charged positively, the more the adsorbed carbon dioxide (hereinafter referred to as “CO₂ (a)”) is desorbed easily to be CO₂ (g) rather than dissociated into adsorbed carbon monoxide and oxygen atoms (hereinafter referred to, respectively, as “CO (a)” and “O (a)”).

(2) Also, the inhibitor, which exists on the surface of the active component, the interface of the support, and the surface of the support in the vicinity, exhibits an effect of selectively covering CO₂ adsorption sites to block the reaction between CO₂ and H₂.

The present invention thus achieves a catalyst for selectively transforming CO into methane while selectively inhibiting (suppressing) CO₂ methanation reaction.

In one preferred implementation, the active component is at least one selected from the group consisting of nickel, ruthenium, and platinum.

In one preferred implementation, the oxide support contains at least one selected from the group consisting of nickel, aluminum, titanium, silicon, zirconium, and cerium.

These constituent metals are widely used in this kind of catalyst and easily available industrially.

In one preferred implementation, the methanation reaction inhibitor contains one or more selected from the group consisting of fluorine, chlorine, bromine, iodine, hydrochloric acid, nitric acid, sulfuric acid, phosphoric acid, boric acid, vanadium acid, tungsten acid, and chromic acid.

More specifically, the methanation reaction inhibitor is prepared by adding ammonium chloride, ammonium borate, ammonium sulfate, ammonium vanadate or the like to a constituent of the catalyst and burning it.

These reaction inhibitors have not been recognized as a component usable for inhibiting (suppressing) methanation of CO₂ in H₂ gas.

The followings are exemplary techniques useful in predicting the performance of and managing the catalyst according to the present invention.

The selective CO methanation catalyst may be arranged such that carbon dioxide adsorbed on the surface of the active component has a desorption activation energy of 10 kJ/mol or lower.

The desorption activation energy may be calculated through a commonly known density-functional approach by obtaining the energy of a stable structure in which carbon dioxide is adsorbed on the surface of the active metal having a specific charge and a transitional structure in which carbon dioxide is being desorbed and subtracting the value of the adsorbed state from that of the transitional state.

The selective CO methanation catalyst may be arranged such that given that the linear CO adsorption-equivalent peak area for CO adsorption through a Fourier transform infrared spectroscopy of the catalyst is 1.0, the linear CO adsorption-equivalent peak area for CO₂ adsorption is 0.01 to 0.15.

In the arrangement above, the peak area for CO and CO₂ may be measured using a common diffuse reflection-type Fourier transform infrared spectrophotometer, which can heat a sample while reaction gas flows therethrough. The linear CO adsorption-equivalent peak area may be calculated using a spectrum obtained after applying CO or CO₂ of a predetermined concentration to a catalyst heated to a reaction temperature and purging unnecessary gas with He.

The present invention is also directed to a process for producing a selective CO methanation catalyst including the steps of producing an oxide support, adding a catalyst active component, and adding a carbon dioxide methanation reaction inhibitor.

In one preferred implementation, the steps of producing an oxide support and adding a carbon dioxide methanation reaction inhibitor are carried out concurrently by using a coprecipitation technique to precipitate the oxide support and the methanation reaction inhibitor from solution with raw salts for the oxide support and the methanation reaction inhibitor dissolved therein.

The process above is a specific method for industrially producing a catalyst according to the present invention. In particular, a fine support of nanometer order with active metal particles distributing and precipitating homogeneously thereon would have a high CO methanation reaction efficiency.

The present invention further provides a CO methanation method using such a catalyst as mentioned above.

In a fuel reformation process for producing hydrogen gas from a hydrocarbon fuel for supply to a fuel cell, the method is for selectively transforming carbon monoxide in hydrogen gas under reformation containing carbon monoxide and carbon dioxide into methane by bringing the carbon monoxide into contact with a catalyst, in which the catalyst includes an oxide support with at least one of a noble metal and a transition metal supported thereon as an active component, and at least one of a halogen, an inorganic acid, and a metal oxo-acid adsorbed or bonded thereto as a carbon dioxide methanation reaction inhibitor.

In one preferred implementation, the method includes supplying gas or solution containing the methanation reaction inhibitor to the catalyst.

This method of supply can maintain or recover the performance of the reaction inhibitor by bringing gas or solution containing the inhibitor into contact with the methanation catalyst when the hydrogen gas refining reaction is inactive. This is an economical technique useful when the performance of the catalyst is degraded, by which the catalyst can have a longer life.

The present invention further provides a fuel reformer utilizing such a catalyst as mentioned above.

The present invention is directed to a fuel reformer for producing hydrogen gas from a hydrocarbon fuel for supply to a fuel cell, including a selective CO methanation reactor for selectively transforming carbon monoxide in hydrogen gas under reformation containing carbon monoxide and carbon dioxide into methane, in which the selective CO methanation reactor includes a catalyst for selectively transforming carbon monoxide into methane, and in which the catalyst includes an oxide support with at least one of a noble metal and a transition metal supported thereon as an active component, and at least one of a halogen, an inorganic acid, and a metal oxo-acid adsorbed or bonded thereto as a carbon dioxide methanation reaction inhibitor.

As a measure useful when the performance of the catalyst is degraded, the fuel reformer preferably further includes an apparatus for supplying gas or solution containing the methanation reaction inhibitor to the selective CO methanation reactor.

### BRIEF DESCRIPTION OF THE DRAWINGS

FIGS. 1a to 1c show exemplary configurations (concepts and models basically) of a selective CO methanation catalyst according to the present invention;

FIG. 2 shows the overall flow of a hydrogen production system;

FIG. 3 is a block diagram schematically showing the overall configuration of the hydrogen production system;

FIGS. 4a and 4b are perspective views showing exemplary honeycomb base materials;

FIG. 5 shows the structure of a selective CO methanation catalyst layer in which honeycombs are arranged in catalyst stages;

FIG. 6 is a block diagram showing the overall configuration of another hydrogen production system;

FIG. 7 is a block diagram of a catalyst performance evaluator;

FIGS. 8a to 8e are graphs showing the performance of a common methanation catalyst with a low CO methanation reaction selectivity;

FIGS. 9a to 9e are graphs showing the performance of a selective CO methanation catalyst using ammonium chloride as a methanation reaction inhibitor;

FIG. 10 is a graph showing the quantitative relationship between the amount of chlorine Cl on the surface of the catalyst and the reaction selectivity;

FIGS. 11a to 11e are graphs showing the performance of a selective CO methanation catalyst using ammonium borate as a methanation reaction inhibitor;

FIGS. 12a to 12e are graphs showing the performance of a selective CO methanation catalyst using ammonium sulfate as a methanation reaction inhibitor;

FIGS. 13a to 13e are graphs showing the performance of a selective CO methanation catalyst using ammonium vanadate as a methanation reaction inhibitor;

FIGS. 14a to 14e are graphs showing the performance of a selective CO methanation catalyst prepared by adding a methanation reaction inhibitor to a support;

FIG. 15 is a graph showing evaluation results of CO and CO₂ adsorption tests through an FT-IR of a common methanation catalyst;

FIG. 16 is a graph showing evaluation results of CO and CO₂ adsorption tests through an FT-IR of a selective CO methanation catalyst with a methanation reaction inhibitor added thereto;

FIG. 17a is a schematic view showing CO₂ adsorption and desorption on the surface of Ni particles, one of active metal species, and FIG. 17b shows computationally obtained changes in the CO₂ adsorption and desorption energy diagram when a reaction inhibitor effects a change in the charge on the surface of Ni particles;

FIGS. 18a and 18b are graphs showing the performance of selective CO methanation catalysts prepared using a coprecipitation technique and having their respective different support amounts of Ni;

FIGS. 19a to 19e are graphs showing the performance of selective CO methanation catalysts prepared using a coprecipitation technique and having their respective different vanadium ratios;

FIGS. 20a to 20e are graphs showing methanation activity evaluation results of a catalyst in a practical example in which nickel serving as an active metal and ammonium vanadate serving as a methanation reaction inhibitor are added concurrently to γ-alumina serving as a catalyst support; and

FIGS. 21a to 21d are graphs showing the performance of a selective CO methanation catalyst using ammonium molybdate as a reaction inhibitor.

### DESCRIPTION OF THE PREFERRED EMBODIMENTS

Embodiments of the present invention will hereinafter be described.

### [Overall Configuration of the System]

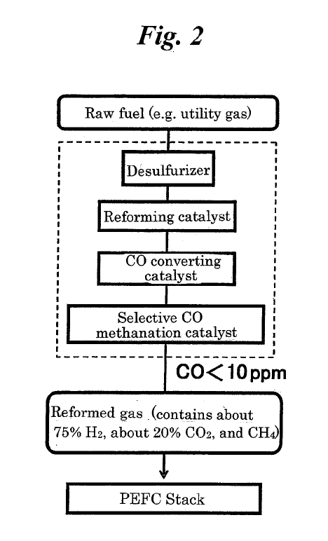

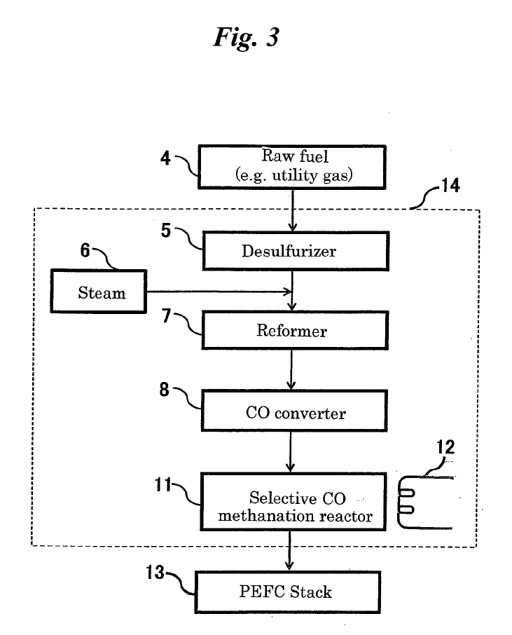

FIGS. 2 and 3 schematically show the flow and overall configuration of a system for producing and purifying high-concentration hydrogen gas from raw fuel (e.g. utility gas) to be supplied to fuel cells (e.g. polymer electrolyte fuel cells (PEFC stacks)). The section enclosed by the dashed line corresponds to a fuel reformer (fuel processing apparatus) 14 in which raw fuel from a raw fuel supply system 4 flows to pass through each catalyst layer and undergo reformation and CO removal (10 ppm or less) to be high-concentration hydrogen gas (reformed gas contains about 75% H₂ and about 20% CO₂).

The raw fuel flows first through a desulfurizer 5 where sulfur components are removed, secondly a reformer 7 including a reforming catalyst layer where hydrogen (H₂) and carbon monoxide (CO) are produced through reforming reaction (steam reforming using steam from a steam generator 6), and further a CO converter 8 including a CO converting catalyst layer where CO is removed. This arrangement is the same as that of conventional apparatuses.

Gases containing about 0.5 to 1.0% CO(H₂, CO₂, etc.) flow into a selective CO methanation reactor 11 including a selective CO methanation catalyst layer using a selective CO methanation catalyst according to the present invention to be high-concentration H₂ gas (reformed gas) with a CO concentration of 10 ppm or less therethrough and supplied to a PEFC stack 13. The reference numeral 12 denotes a temperature control system.

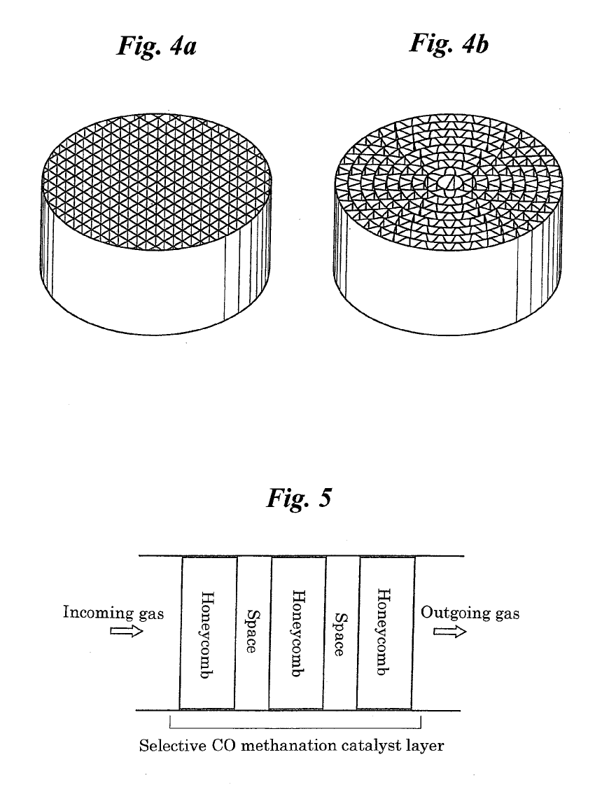

The selective CO methanation catalyst is preferably used in a manner coated on a honeycomb base material. FIGS. 4a and 4b show exemplary honeycomb base materials. FIG. 4a shows an exemplary cordierite honeycomb base material and FIG. 4b shows an exemplary metal honeycomb base material. In either case, many longitudinally-arranged matrix-like, diagonal, or waveform partition plates (partition walls) are provided in an intersecting manner inside a cylinder (circular, rectangular, etc. in cros section), where gases pass between adjacent partition plates. The surface of each partition plate is coated entirely with a selective CO methanation catalyst. Honeycomb structures having gas passages (flow paths) (cells) of not only hexagonal, but also quadrilateral, sinusoidal, or other shaped cross section are herein referred to merely as honeycomb or honeycomb base material.

As shown in FIG. 5, multiple honeycombs with a selective CO methanation catalyst coated thereon are preferably arranged separately in multiple stages in the direction of gas flow in the reactor 11.

The entire fuel processing apparatus shown in FIG. 3 or a part thereof (including at least the selective CO methanation reactor 11, for example) may represent a fuel reformer or a hydrogen producing and purifying apparatus.

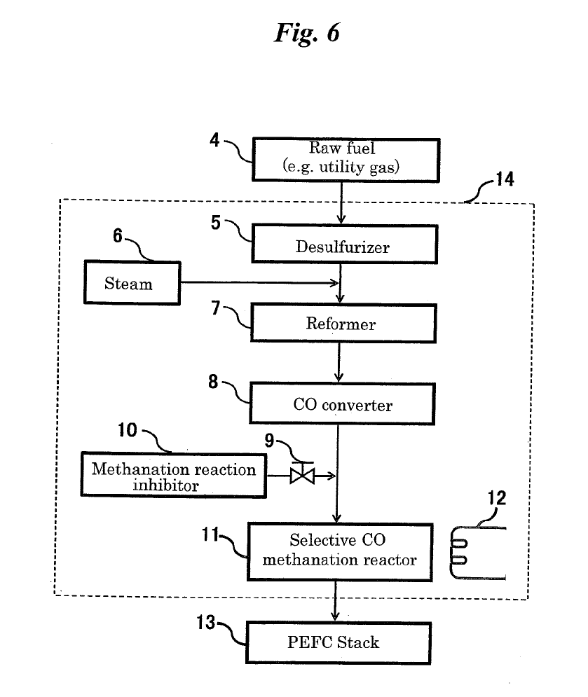

FIG. 6 shows a system configuration added with components for recovering, when degraded, the performance of the selective CO methanation catalyst in the selective CO methanation reactor 11. In this figure, components identical to those shown in FIG. 3 are designated by the same reference numerals to avoid redundant description.

The system includes a methanation reaction inhibitor supply system (tank) 10 and a valve 9, and is arranged to supply gas or solution containing a methanation reaction inhibitor from the supply system 10 to the selective CO methanation catalyst in the reactor 11. The valve 9 is normally closed and can be opened when the hydrogen gas refining reaction is inactive, for example, to cause the gas or solution containing the reaction inhibitor to come into contact with the methanation catalyst in the reactor 11 for maintenance or recovery of the performance of the methanation reactor inhibitor. This allows the selective CO methanation catalyst to have a longer life.

### [Configuration of the Catalyst]

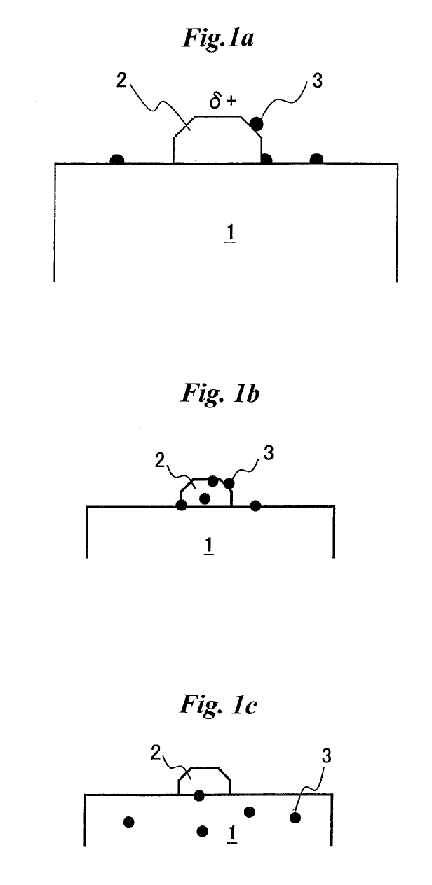

FIG. 1a shows a basic concept of the catalyst according to the present invention. Active metal particles 2 are supported on the surface of a support 1 and on the surface thereof is dispersed a methanation reaction inhibitor 3 for selectively inhibiting carbon dioxide methanation reaction.

The methanation reaction inhibitor 3 effects a positive charge (δ+) on the surface of the active metal particles 2.

The support 1 may employ a variety of metal oxides, composite oxides, nitrides, carbides, and mixtures thereof, but is preferably an oxide or a composite oxide from the viewpoint of catalytic activity and, in particular, contains at least one selected from the group consisting of nickel, aluminum, titanium, silicon, zirconium, and cerium.

The active metal particles 2 can employ a variety of transition, alkaline, and alkaline-earth metals, but preferably a transition metal and, in particular, contains at least one selected from the group consisting of nickel, ruthenium, and platinum to achieve high activity.

The CO₂ methanation reaction inhibitor 3 may employ a variety of materials that can effect a positive charge (δ+) on the surface of the active metal or inhibit CO₂ methanation activity and, in particular, preferably contain one or two or more of halogens such as F, Cl, Br, and I, inorganic acids such as HCl, HNO₃, H₂SO₄, and H₃PO₄, and metal oxo-acids such as boric acid, vanadium acid, tungsten acid, and chromic acid. The form in which the inhibitor exists on the catalyst depends on its production process and is not restricted to such compounds but may be a precursor, a reactant, or a decomposition (degradation) product thereof.

FIG. 1a shows a model in which the CO₂ methanation reaction inhibitor 3 is first added and then the active metal particles 2 are supported onto the support 1 (corresponding to the first, fourth, and sixth practical examples to be described hereinafter) or the active metal particles 2 are first supported and then the CO₂ methanation reaction inhibitor 3 is added onto the support 1 (corresponding to the second, third, and fifth practical examples to be described hereinafter). In this model, the CO₂ methanation reaction inhibitor 3 is mainly bonded or adsorbed to the surface of the support 1 and the metal particles 2.

On the other hand, FIG. 1b shows a model in which the active metal particles 2 and the CO₂ methanation reaction inhibitor 3 are added concurrently onto the support 1. In this model, the inhibitor 3 is also bonded or adsorbed to the interface between the active metal particles 2 and the support 1 and the inside of the metal particles 2 (corresponding to the eleventh practical example to be described hereinafter).

FIG. 1c shows a model in which the CO₂ methanation reaction inhibitor 3 is mixed during the preparation of the support 1 (using a coprecipitation technique). In this model, the inhibitor 3 is further placed inside the support 1 (corresponding to the ninth and tenth practical examples to be described hereinafter).

Practical examples of the present invention will hereinafter be described. Prior to the description, a method for preparing a honeycomb catalyst and a method for evaluating the performance of the catalyst that are common to the practical examples and a comparative example will be described collectively.

### [Method for Preparing Honeycomb Catalyst]

The catalyst, though may be used in a granular form or another form selected from a variety of molded forms, was used in the following practical examples as a honeycomb one formed by coating catalyst powder on a honeycomb base material.

First, 3 g of the catalyst powder was added with 6 g of alumina sol (alumina sol 520 from NISSAN CHEMICAL INDUSTRIES, Ltd.) and 25 g of pure water, and then stirred and mixed to prepare a coating slurry. A metal honeycomb was made of stainless steel (YUS205M1) with an outside diameter of 25.4 mm (1 inch φ) and a length of 15 mm from Nippon Steel Sumikin Materials Co., Ltd., the surface thereof being oxidized at high temperature. The number of cells was 400 cpsi (cell per square inch) and the thickness of each cell wall was 30 μm. This metal honeycomb was immersed in the coating slurry, and then lifted up to remove excess slurry inside the catalyst and on the outer wall using an air pump. The coated honeycomb was burned for five minutes in air at 500 degrees C. in an electric furnace and then weighed. This procedure was repeated until the net amount of coating reached 300 g per honeycomb liter and, last of all, the honeycomb was burned for one hour at 500 degrees C. to obtain a honeycomb catalyst with a catalyst layer formed uniformly on the inner wall of each cell.

### [Performance Evaluation]

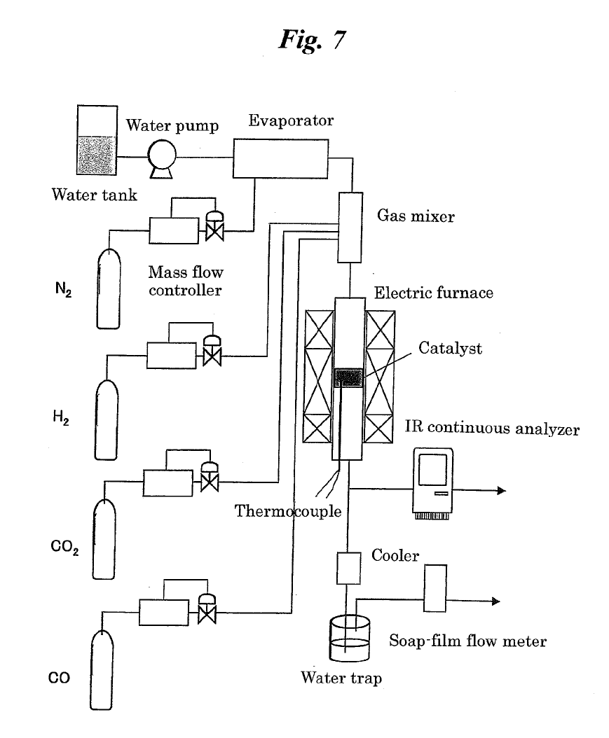

The catalyst coated on the honeycomb base underwent a CO and CO₂ methanation activity evaluation in a fixed-bed atmospheric circulation-type reaction evaluating apparatus shown in FIG. 7. Conditions and procedures of the evaluation will be described below.

Prior to the activity evaluation, the catalyst sample underwent hydrogen reduction. This was for reducing the catalytic activity component. During the reduction, H₂ gas was introduced through a reaction tube at a flow rate of 500 ml/min and heated up to 400 to 500 degrees C. at 20 degrees C./min, and thereafter kept at the temperature for one hour. After the reduction, N₂ gas was introduced for five minutes to purge H₂ gas, and the temperature was lowered to evaluate the activity of the catalyst.

Five minutes after steam was introduced into the reaction tube, reaction gas was introduced. Ion-exchanged water was fed by a micro pump (from ATT MOL Inc.) into a vaporizer kept at 200 degrees C., and generated steam was introduced with N₂ carrier into the reaction tube at a rate of supply of the steam equivalent to steam/CO=34 (molar ratio). Reaction gases were introduced by a mass flow controller into the reaction tube at a composition of 1 vol % CO, 80 vol % H₂, and 19 vol % CO₂ on a dry basis. The superficial velocity SV was 2400 h⁻¹. The reaction tube was made of quartz with an inside diameter of 26 mm. The honeycomb-based catalyst was set in a predetermined position at the center of the reaction tube, and the space between the inner wall of the reaction tube and the honeycomb was filled closely with silica wool so as to be fixed and that gas cannot flow through outside the honeycomb. In the case of cordierite honeycombs, sheathed thermocouples were set, respectively, at positions about 1 mm high and low from the honeycomb catalyst to measure the temperature of the catalyst layers. In the case of honeycomb catalysts, the tip end of the lower sheathed thermocouple was inserted to be placed at 2 to 3 mm in a cell.

Gases outgoing from the reaction tube, after contained moisture was removed at reduced temperature, were introduced into an online FID (from GL SCIENCE Co., Ltd.) including an online TCD gas chromatograph and a methanizer to undergo analysis of produced gases.

The obtained analysis results were plotted for each of H₂, CO₂, CH₄, and CO as a relationship between the concentration and the reaction temperature. The performance of the catalyst can be determined based on the temperature dependence of the gas concentration. For example, if CO is removed at lower temperature, the catalyst is said to have a higher CO methanation activity. Further, if the incoming concentration of CO₂ is maintained without decreasing even at high temperature, the selective CO methanation catalyst is also determined to have a superior performance with sufficiently suppressed (inhibited) CO₂ methanation reaction.

### Comparative Example

Here will be described a method for preparing a methanation catalyst Ru,Ni/NiAlxOy containing no CO₂ methanation reaction inhibitor as a comparative example of the present invention.

First will be described a technique for synthesizing a nickel/aluminum composite oxide. As raw material solution, 4.67 g of nickel nitrate hexahydrate Ni(NO₃)₂.6H₂O and 17.66 g of aluminum nitrate nonahydrate Al(NO₃)₃.9H₂O were dissolved in 100 mL of distilled water to achieve a Ni/Al molar ratio of 0.34. The raw material solution was sprayed with argon mixed gas containing 5% oxygen into argon plasma that was fired at an output power of 100 kW and a frequency of 4 MHz in a low-pressure and high-frequency thermal plasma apparatus. Powder generated via the plasma torch was collected through a filter. This procedure was repeated until a total weight of 500 g of powder is obtained. The collected powder was dark green fine powder obtained at a yield of about 70%. The obtained powder was composite oxide amorphous fine particles containing Ni and Al. As a result of analysis using an energy dispersive X-ray analyzer (EDX), the Ni/Al molar ratio of the powder was found 0.29. As a result of X-ray diffraction (XRD) measurements, no intense diffraction peak was observed that attributes to NiAl₂O₄ or Al₂O₃ crystal. As a result of observations using a transmission electron microscope (TEM), the particle size had a distribution range of 3 to 12 nm.

Nitrosyl ruthenium nitrate (III) solution (Ru(NO)(NO₃)₃ solution from STREM CHEMICALS Inc. with an Ru content of 1.5 wt %) was used to cause the nickel/aluminum composite oxide precursor powder to have a ruthenium content of 1.0 wt %. First, 8.0 g of the composite oxide precursor powder was added with 100 g of deionized water and stirred for ten minutes. Similarly, nitrosyl ruthenium nitrate (III) in an amount with which the metal ruthenium content after supporting would be 1 wt % was added with 28 g of deionized water, and then stirred for ten minutes. This nitrosyl ruthenium nitrate (III) solution was added entirely to the suspension of the composite oxide precursor powder using a burette in about twenty minutes, and then further stirred for ten minutes. The resulting suspension was introduced into an eggplant-shaped flask and stirred for thirty minutes in hot water at 35 to 40 degrees C., and then once cooled down to room temperature and applied to an evaporator at 35 to 40 degrees C. to evaporate moisture. The resulting powder was dried and then burned for five hours at 500 degrees C. in air flowing at 500 ml/min.

The prepared catalyst powder entirely underwent a nitrogen analysis to analyze whether or not the reaction inhibitor contains nitric acid originated from the nitrosyl ruthenium nitrate. The result found that no nitric acid component was detected. It is considered that the nitric acid component was entirely released into gas phase as NOx during 5-hour burning at 500 degrees C. in air.

According to the above-described procedure, the prepared powder was applied to a honeycomb and set in the evaluating apparatus shown in FIG. 7. Prior to the activity evaluation, the catalyst underwent hydrogen reduction for one hour in flowing hydrogen at 500 degrees C. This reduction under the existence of ruthenium causes fine nickel particles to participate from the nickel/aluminum composite oxide to serve as an active metal together with ruthenium and show a high methanation activity. After the reduction, the catalyst was cooled to a catalytic activity evaluation temperature to continuously evaluate the performance of the catalyst.

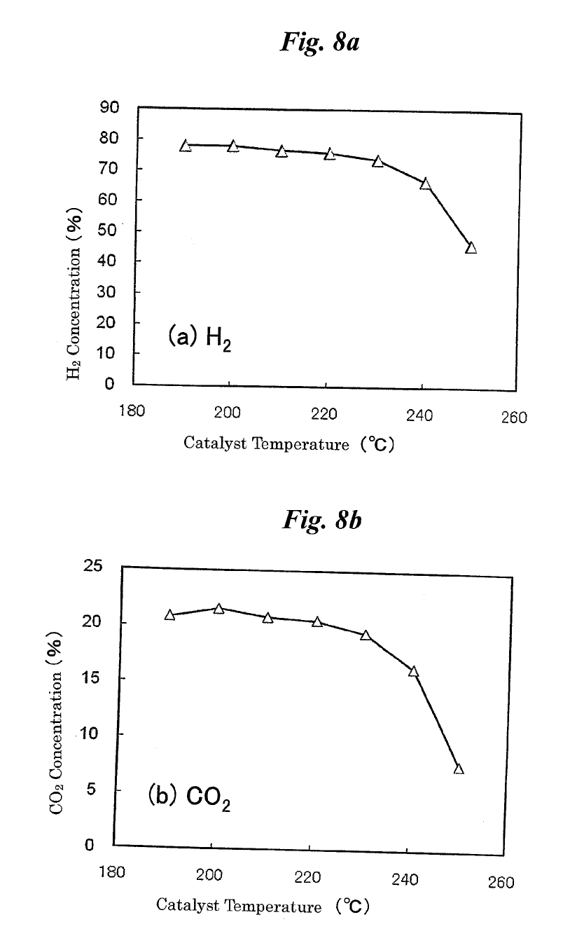

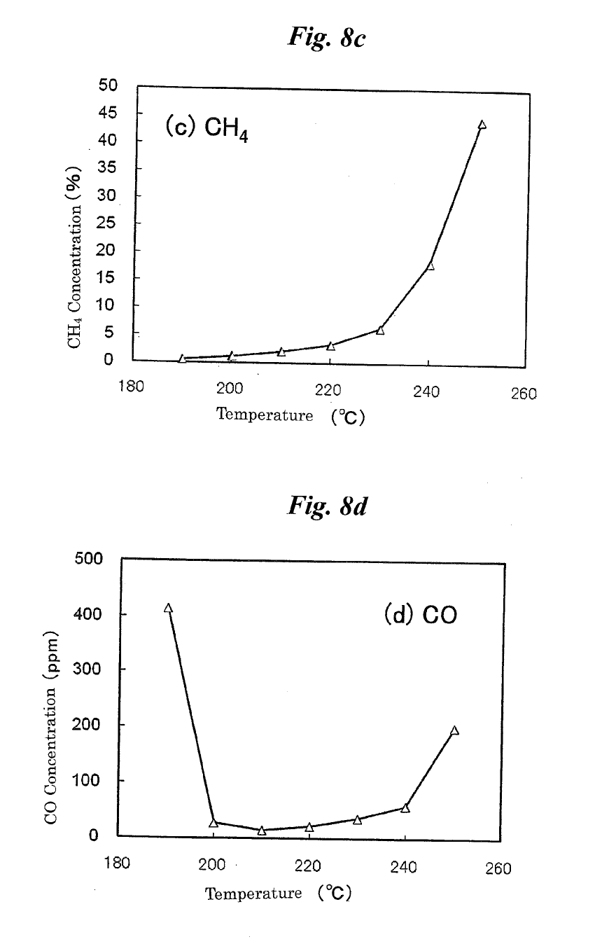

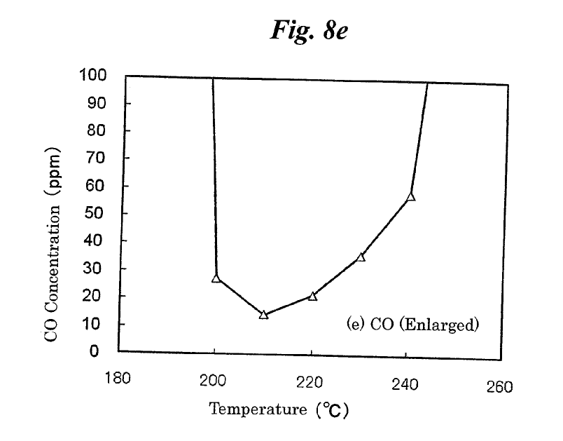

FIGS. 8a to 8e show evaluation results. The concentration starts to decrease rapidly at around 220 degrees C. in (b) CO₂ of FIG. 8b, and accordingly the concentration also decreases in (a) H₂ of FIG. 8a while the concentration increases in (c) CH₄ of FIG. 8c. This clearly shows that the CO₂ methanation reaction of Reaction Formula 3 occurs. Like this catalyst, common methanation catalysts with no reaction inhibitor added thereto have a tendency that the CO₂ methanation reaction is likely to proceed at such a low temperature.

FIGS. 8d and 8e show results of CO concentration ((d) and (e)). FIG. 8e is a replot of FIG. 8d with the vertical axis enlarged to represent the CO concentration in a ppm order. This catalyst starts to remove CO by 99.7% or more at a relatively low temperature of 200 degrees C., but CO increases rapidly at higher temperature due to the reverse water-gas-shift reaction (indicated by Reaction Formula 4). As a result, this catalyst can exclusively transform CO into methane within a limited, very narrow temperature range of 200 to 220 degrees C., and is thus determined to have only an insufficient performance as a practical catalyst.

### PRACTICAL EXAMPLES

### First Practical Example

This practical example describes a method for preparing a selective CO methanation catalyst according to the present invention by adding ammonium chloride as a methanation reaction inhibitor to the same catalyst as in the above-described comparative example.

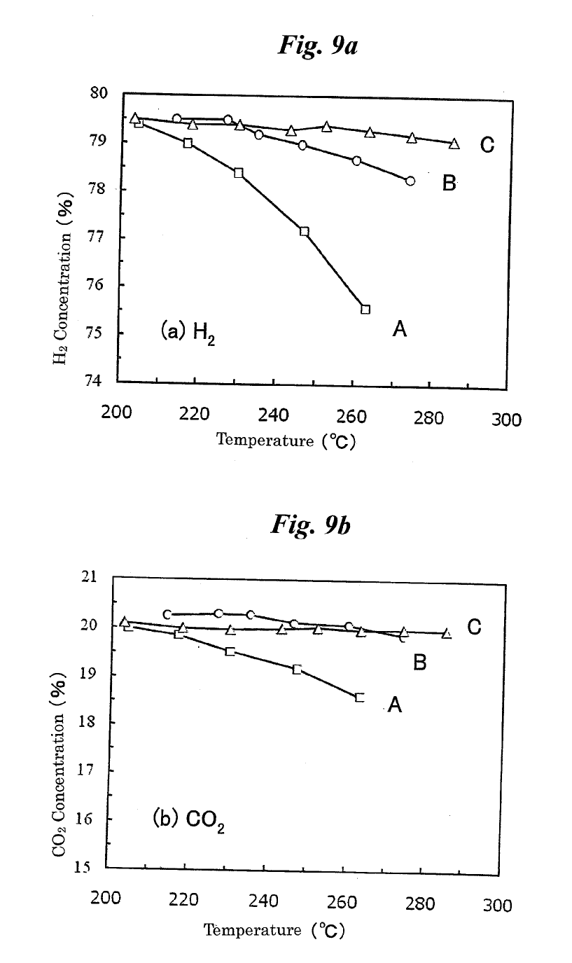

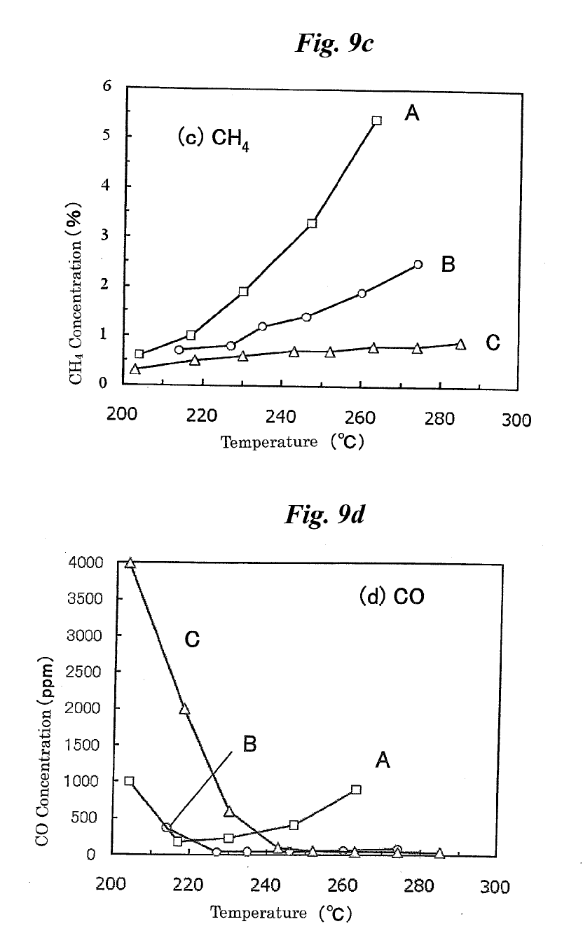

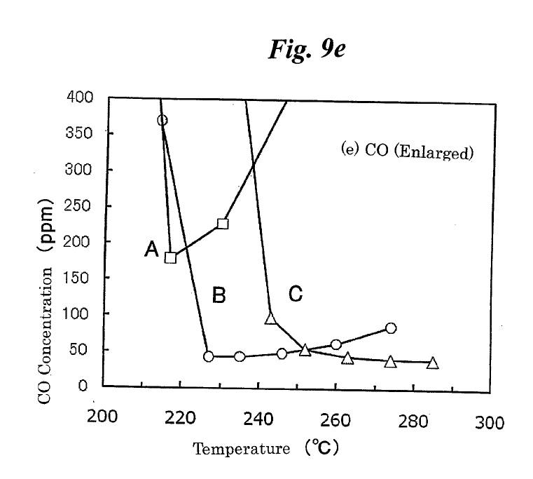

The Ni/Al composite oxide support was added with ruthenium as an active component to produce catalyst powder with a supported content of 1 wt %, and 5.0 g of the powder was dried for one hour at 120 degrees C. and then cooled down to room temperature in a desiccator. Next, 0.045 g of ammonium chloride was dissolved in 2.5 g of deionized water, which is equivalent to the amount of water absorbable by 5.0 g of the catalyst powder. The amount of chlorine (Cl) in the added ammonium chloride was equivalent to three times that in mole of ruthenium contained in the catalyst (plots C in FIGS. 9a to 9e). Ammonium chloride solution was added entirely at one time to the dried catalyst powder and stirred for one to two minutes using a spatula so that the solution permeates the entire powder, and thereafter the mixture was dried for one hour at 110 degrees C. and then burned for three hours at 500 degrees C.

According to the same procedure, samples added with chlorine in an amount equivalent to that in mole of ruthenium (plots B in FIGS. 9a to 9e) and to 0.5 times that in mole of ruthenium (plots A in FIGS. 9a to 9e) contained in the catalyst were also prepared. The resulting selective CO methanation catalyst powder was applied to a honeycomb according to the above-described procedure and underwent catalytic activity evaluations.

FIGS. 9a to 9e show evaluation results. In this practical example, in which ammonium chloride was added to the same catalyst as in the above-described comparative example, the larger the additive amount of ammonium chloride, the larger the amount of curb of the increase in the CH₄ concentration and the decrease in the H₂ and CO₂ concentration on the high-temperature side, as shown in FIGS. 9a to 9e. Compared to FIGS. 8a to 8c where no ammonium chloride was added, it is more clearly understood that the catalyst has a higher CO₂ methanation reaction inhibiting (suppressing) effect.

Referring now to FIG. 9d, CO outgoing from the catalyst is removed to approximately the same degree independently of the additive amount of ammonium chloride. The temperature at which CO methanation reaction can occur tends to shift toward the high-temperature side with the increase in the amount of the reaction inhibitor. This is believed to be due to the fact that the reaction inhibiting effect by ammonium chloride also has a small impact on CO methanation reaction.

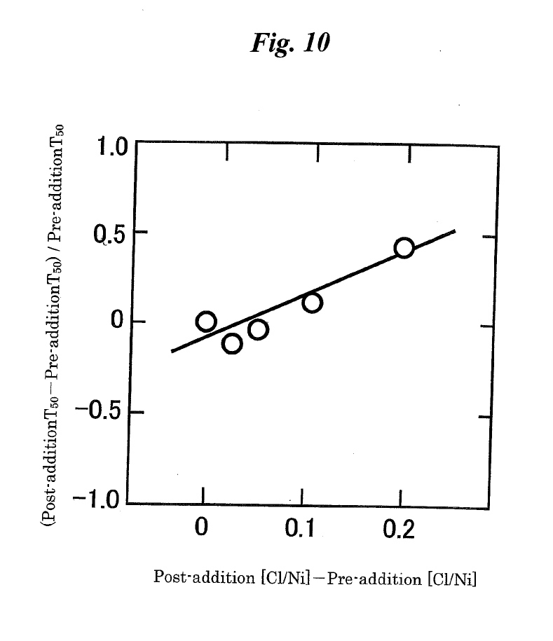

FIG. 10 shows the CO₂ methanation activity of the catalyst with ammonium chloride added therein at various concentrations against the amount of Cl on the surface of the catalyst. The horizontal axis represents the Cl/Ni molar ratio on the surface of the catalyst, which was analyzed using an X-ray Photoelectron Spectrometer (XPS), normalized by the difference between the values before and after the addition of the reaction inhibitor. The vertical axis represents the temperature at which the concentration of CH₄ outgoing from the catalyst is twice the incoming concentration of CO, that is, the temperature T₅₀ at which the CO selectivity (the ratio of CH₄ produced from CO among the whole CH₄) is 50%, which was obtained experimentally, similarly normalized by the difference between the values before and after the addition of the reaction inhibitor. This result clearly shows that there is a positive correlation between the normalized T₅₀ and the normalized amount of Cl and that the larger the amount of Cl, the higher the temperature at which CO₂ methanation reaction occurs becomes, that is, the more CO₂ methanation reaction is inhibited effectively.

### Second Practical Example

In this practical example, a nickel/aluminum composite oxide prepared using a coprecipitation technique underwent direct hydrogen reduction with no ruthenium being supported thereon. Nickel was an only active metal in this practical example. Further, instead of ammonium chloride, ammonium borate was used as a methanation reaction inhibitor.

Ammonium carbonate solution was added by drops in about fifteen minutes to solution with nickel nitrate and aluminum nitrate dissolved therein in the same amount in mole and stirred at 2500 rpm until the solution had a pH of 8, and further the solution was stirred for another thirty minutes. The precipitation was filtered through a membrane filter of 0.2 μm and then sufficiently rinsed in 1 L of pure water. The resulting precipitation was dried half a day under a low-pressure atmosphere at room temperature and then dried for twelve hours at 110 degrees C. The resulting gel was grinded and pulverized, and then burned for three hours at 500 degrees C. in air to obtain nickel/aluminum composite oxide powder.

Since no ruthenium was supported in this practical example, the nickel/aluminum composite oxide underwent reduction for one hour in flowing hydrogen at 700 degrees C., which is higher than in the first practical example. Methanation catalyst powder Ni/Ni_{0.5}Al_{0.5} Oy was thus prepared in which nickel particles precipitated on the composite oxide support.

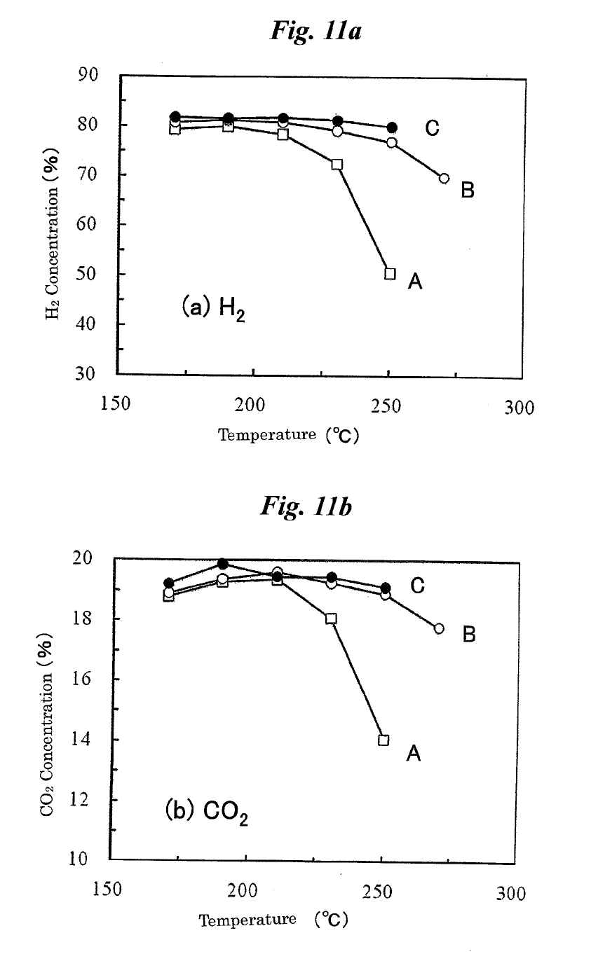

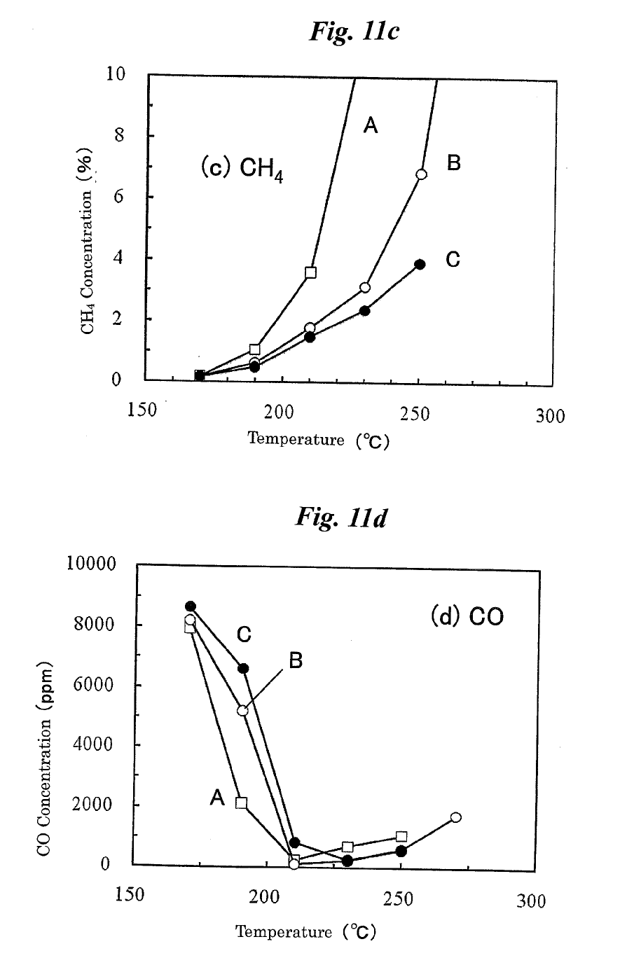

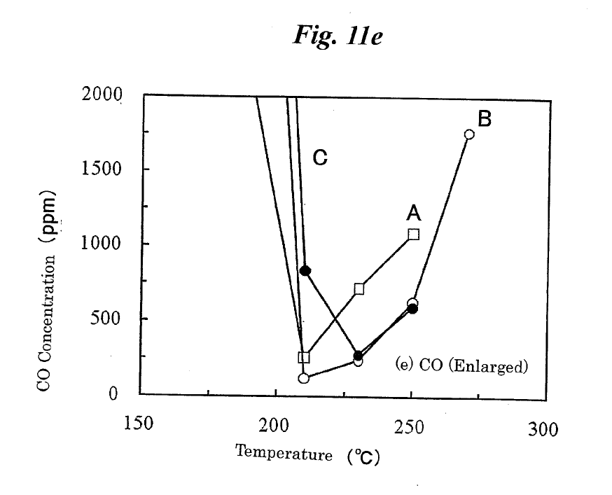

Next, solution prepared by dissolving 1.61 g of ammonium borate ((NH₄)₂O.5B₂O₃.8H₂O) in 15 g of deionized water was added entirely to 10.0 g of the methanation catalyst powder and stirred for one to two minutes using a spatula so that the solution permeates the entire powder, and thereafter the mixture was dried for one hour at 110 degrees C. and then burned for three hours at 500 degrees C. (plots C in FIGS. 11a to 11e).

According to the above-described procedure, a honeycomb catalyst was prepared using the resulting catalyst powder. Prior to the methanation activity evaluation, the catalyst underwent hydrogen reduction for one hour at 500 degrees C. to prevent boric acid from melting and flowing out. According to the same procedure, samples added with ammonium borate in a weight half that above (plots B in FIGS. 11a to 11e) and no ammonium borate (plots A in FIGS. 11a to le) were also prepared.

FIGS. 11a to 11e show evaluation results. These results show that even if ammonium borate may be used as a reaction inhibitor, CO₂ methanation reaction is inhibited and that the larger the additive amount, the more the reaction is inhibited effectively, as is the case with ammonium chloride. From FIG. 11e, this catalyst has a somewhat higher reachable CO concentration of 100 to 250 ppm, which indicates the necessity of increasing the amount of the catalyst for practical applications relative to the condition in this practical example. However, this catalyst can be prepared using the coprecipitation technique, which is suitable for mass production, and without using ruthenium, a noble metal, whereby the cost for the catalyst can be rather reduced. Although the larger the additive amount of ammonium borate, the higher the temperature at which CO methanation reaction occurs becomes, as is the case with ammonium chloride, the temperature shift is small.

### Third Practical Example

In this practical example, instead of ammonium borate as used in the second practical example, ammonium sulfate was used as a methanation reaction inhibitor.

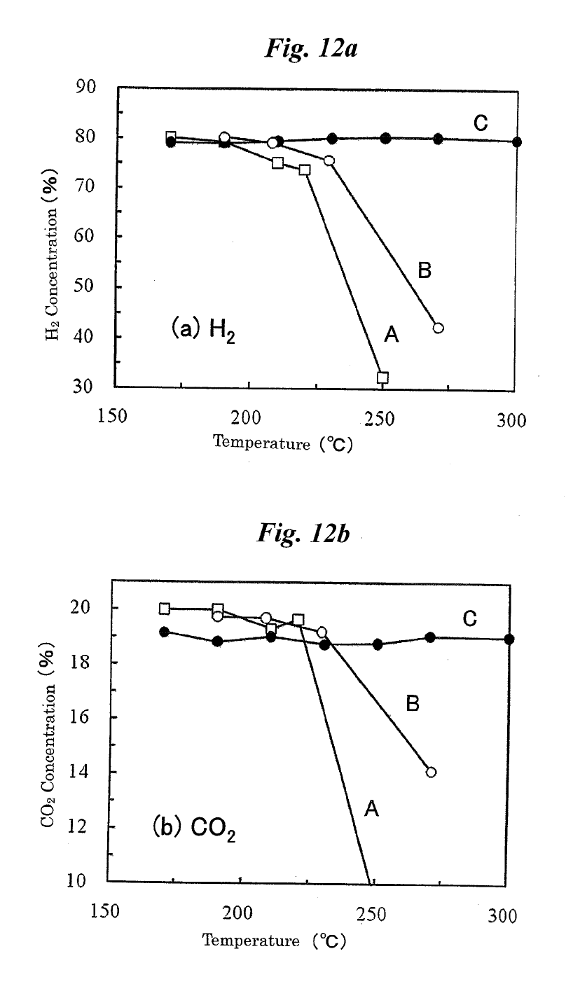

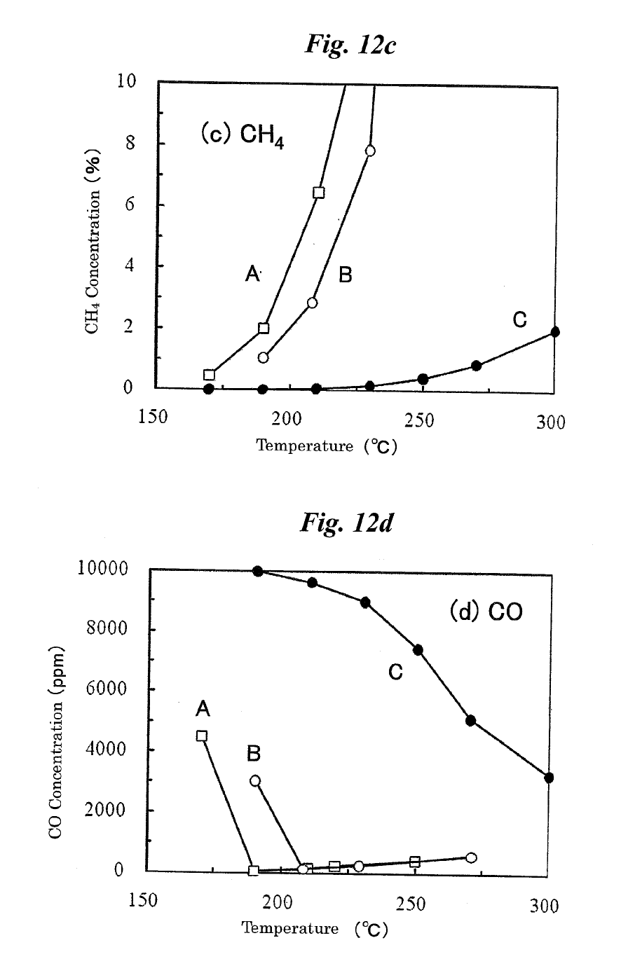

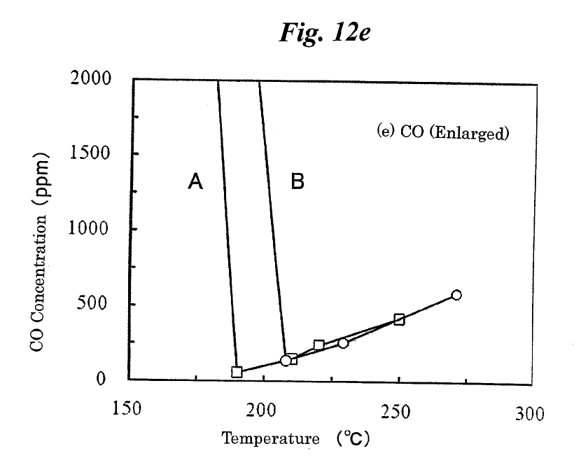

First, nickel/aluminum composite oxide powder prepared according to the coprecipitation technique described in the second practical example underwent reduction for one hour in flowing hydrogen at 700 degrees C. Methanation catalyst powder Ni/Ni_{0.5}Al_{0.5} Oy was thus prepared in which nickel particles precipitated on the composite oxide support. Next, solution prepared by dissolving 0.39 g of ammonium sulfate in 15 g of deionized water was added entirely to 10.0 g of the methanation catalyst powder and stirred for one to two minutes using a spatula so that the solution permeates the entire powder, and thereafter the mixture was dried for one hour at 110 degrees C. and then burned for three hours at 500 degrees C. (plots C in FIGS. 12a to 12e).

According to the above-described procedure, a honeycomb catalyst was prepared using the resulting catalyst powder. The catalyst underwent reduction for one hour in flowing hydrogen at 700 degrees C. and then a methanation activity evaluation according to the procedure described in the second practical example. According to the same procedure, samples added with ammonium sulfate in an amount one-fifth that above (plots B in FIGS. 12a to 12e) and no ammonium sulfate (plots A in FIGS. 12a to 12e) were also prepared.

FIGS. 12a to 12e show evaluation results. These results show that even if ammonium sulfate may be used, CO₂ methanation reaction is inhibited sufficiently, as is the case with ammonium chloride and ammonium borate. However, from the results shown in FIGS. 12d and 12e, the addition of 0.39 g of ammonium sulfate to 10 g of the methanation catalyst unintentionally inhibits (suppresses) CO methanation reaction significantly (see plots C). It is therefore desirable to further adjust the additive amount or apply the inhibitor to another catalyst that can exhibit a better effect.

### Fourth Practical Example

This practical example describes a method for preparing a selective CO methanation catalyst according to the present invention by adding ammonium vanadate as a reaction inhibitor to the methanation catalyst in the above-described comparative example.

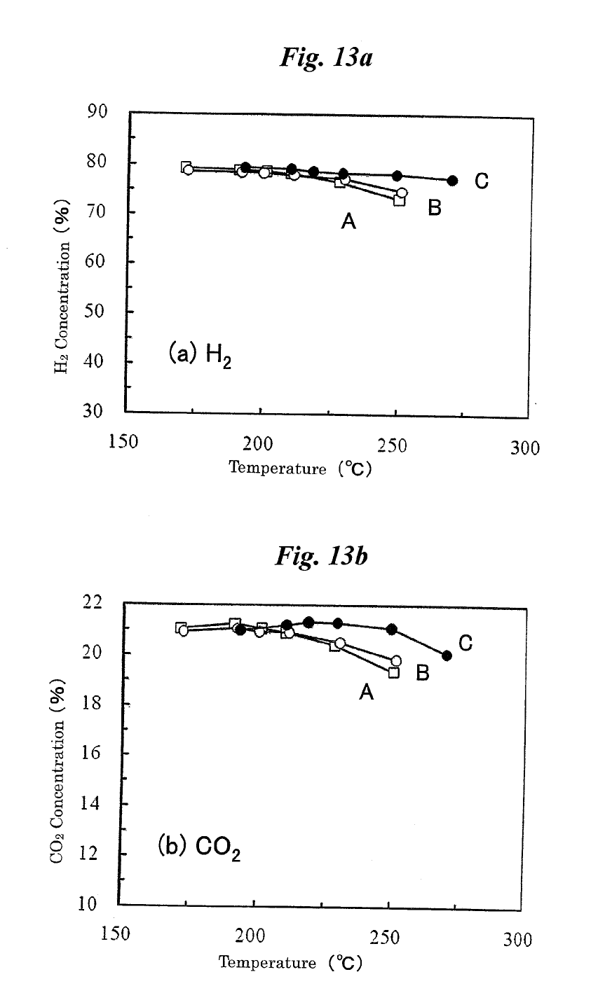

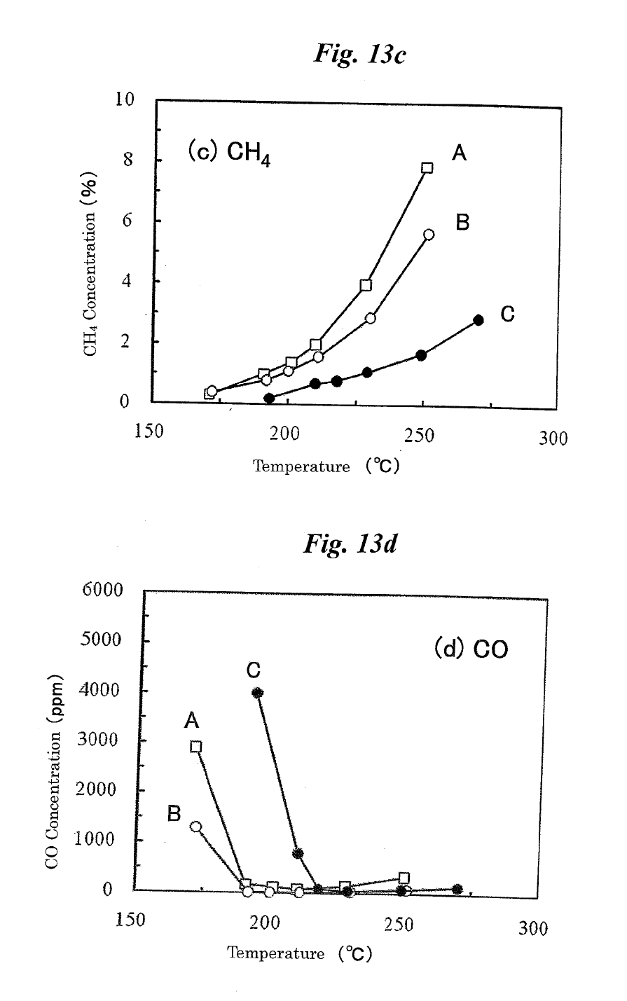

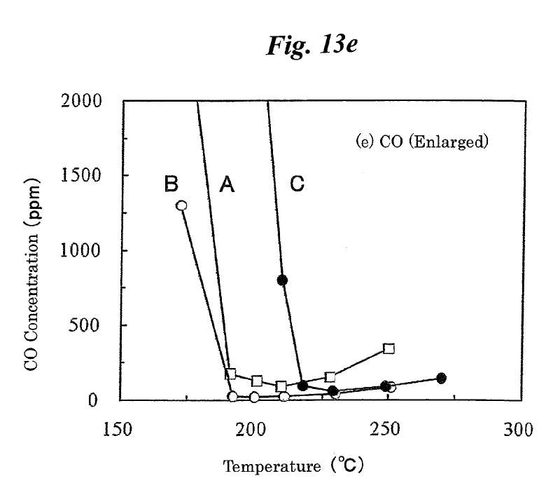

First, 10.0 g of the nickel/aluminum composite oxide powder in the comparative example was suspended in 50 g of ultrapure water. Next, 0.92 g of (NH₄)VO₃ (in Cica grade from KANTO CHEMICAL Co., Inc.) was added to 100 g of ultrapure water and heated for one hour to be dissolved, and then the solution was entirely added by drops in about ten minutes to the suspension of the composite oxide powder (plots B in FIGS. 13a to 13e). During this procedure, the temperature was kept at 60 degrees C. using a hot stirrer. The resulting suspension was transferred to an eggplant-shaped flask and stirred and homogenized under ordinary pressure at 45 degrees C. in an evaporator, and then cooled down to 35 degrees C. for evaporation. The resulting gel was dried for three hours at 110 degrees C. and grinded and pulverized for about fifteen minutes in an automatic mortar, and thereafter heated in air in an electric furnace up to 500 degrees C. in six hours and then burned for five hours at 500 degrees C.

A precursor was thus obtained in which ammonium vanadate was dispersed as a methanation reaction inhibitor in the nickel/aluminum composite oxide. The methanation reaction inhibitor is believed to exist in the form of vanadium oxide, but the form was not analyzed through XRD. Ruthenium was supported on (added to) the resulting powder as follows. First, 8.71 g of the powder was suspended in 70 ml of ultrapure water. Next, 5.42 g of Ru(NO)(NO₃)₃ solution was stirred for fifteen minutes in 50 ml of ultrapure water to be dissolved, and then added by drops in about fifteen minutes to the suspension of the powder. The resulting suspension was transferred to an eggplant-shaped flask and stirred and homogenized under ordinary pressure at 45 degrees C. in an evaporator, and then cooled down to degrees C. for evaporation. The resulting gel was dried for twelve hours at 110 degrees C., and thereafter heated in air in an electric furnace up to 500 degrees C. in five hours and then burned for three hours at 500 degrees C., and further grinded and pulverized for about thirty minutes in an automatic mortar. According to the same procedure, samples added with (NH₄)VO₃ in an amount two-and-a-half times that above (plots C in FIGS. 13a to 13e) and no (NH₄)VO₃ (plots A in FIGS. 13a to 13e) were also prepared.

According to the above-described procedure, the resulting selective CO methanation catalyst powder was applied to a honeycomb and underwent a methanation activity evaluation. Prior to the activity evaluation, the catalyst underwent hydrogen reduction for one hour at 700 degrees C. in this practical example.

FIGS. 13a to 13e show methanation activity evaluation results of each catalyst. Compared to the catalyst (plots A) with no vanadium oxide added therein as a methanation inhibitor, the catalysts with vanadium oxide added therein have a tendency that the larger the additive amount, the larger the amount of curb of the increase in the CH₄ concentration and the decrease in the H₂ and CO₂ concentration on the high-temperature side. This clearly shows that vanadium has an effect of inhibiting (suppressing) CO₂ methanation reaction.

### Fifth Practical Example

In the above-described practical examples, nickel/aluminum composite oxide was used as a support on which nickel precipitated through reduction. In this practical example, γ-alumina, a single oxide, was used as a support on which nickel nitrate was supported through impregnation. Ammonium chloride was used as a methanation reaction inhibitor and, after burning, nickel nitrate was supported thereon through impregnation.

First, 7.6 g of γ-alumina powder was introduced into 30 g of deionized water to prepare a suspension. Next, 4.5 g of nickel nitrate hexahydrate Ni(NO₃)₂.6H₂O, with which metal nickel would have a content of 10 wt %, was added in 20 g of deionized water and stirred for ten minute to be dissolved. The nickel nitrate solution was then added entirely to the suspension of the γ-alumina powder using a burette in about twenty minutes and then stirred for ten minute. The resulting suspension was transferred to an eggplant-shaped flask and stirred for thirty minutes in hot water at 35 to 40 degrees C., and thereafter once cooled down to room temperature and applied to an evaporator at 35 to 40 degrees C. to evaporate moisture. The resulting powder was dried overnight at 120 degrees C. and then burned for five hours in air at 500 degrees C.

Next, the prepared methanation catalyst Ni/γ—Al₂O₃ was added with chlorine from ammonium chloride as a methanation reaction inhibitor. Then 5.0 g of the methanation catalyst powder was dried for one hour at 120 degrees C. and cooled down to room temperature in a desiccator. Next, 0.045 g of ammonium chloride was dissolved in 2.5 g of deionized water, which is equivalent to the amount of water absorbable by 5.0 g of the catalyst powder. The amount of chlorine in the added ammonium chloride was equivalent to three times that in mole of nickel contained in the catalyst. Ammonium chloride solution was added entirely at one time to the dried catalyst powder and stirred for one to two minutes using a spatula so that the solution permeates the entire powder, and thereafter the mixture was dried for one hour at 110 degrees C. and then burned for three hours at 500 degrees C.

The Ni/γ—Al₂O₃ catalyst shows a temperature of about 220 degrees C. at which the concentration of CH₄ in outgoing gas exceeds 1.6% (i.e. the CO selectivity is 50%), while the catalyst with ammonium chloride added therein shows an increased temperature of 240 degrees C. It was confirmed that the addition of a reaction inhibitor is also advantageous in the method of this practical example for supporting an active metal on a common single oxide support through impregnation. In addition, the temperature at which CO methanation reaction starts is 200 degrees C., which is equivalent to that of the foregoing catalysts, but the ratio of CO removal cannot exceed 90% significantly, which indicates the necessity of increasing the amount of the catalyst for practical applications.

### Sixth Practical Example

In this practical example, titanium oxide was used as a support instead of γ-alumina as used in the fifth practical example. Nickel was supported as an active metal through impregnation. Ammonium chloride was used as a methanation reaction inhibitor and a method of first impregnating TiO₂ powder was employed.

Ammonium chloride was used to prepare titanium oxide powder containing chlorine at 0.1 wt % according to the procedure described in first practical example. First, 10.0 g of titanium oxide powder containing chlorine was introduced into 30 g of deionized water to prepare a suspension. Next, 4.95 g of nickel nitrate hexahydrate Ni(NO₃)₂.6H₂O, with which metal nickel would have a content of 10 wt %, was added in 15 g of deionized water and stirred for ten minute to be dissolved. The nickel nitrate solution was then added entirely to the suspension of the titanium oxide powder using a burette in about twenty minutes and then stirred for ten minute. The resulting suspension was transferred to an eggplant-shaped flask and stirred for thirty minutes in hot water at 35 to 40 degrees C., and thereafter once cooled down to room temperature and applied to an evaporator at 35 to 40 degrees C. to evaporate moisture. The resulting powder was dried overnight at 110 degrees C. and then burned for three hours in air at 450 degrees C.

In this practical example, the catalyst powder was not applied to a honeycomb, but molded to have a particle size of 1.2 to 2.0 mm using a tableting machine, and the catalyst activity was evaluated using the above-described evaluating apparatus. The incoming gas had a composition of 1% CO, 20% CO₂, and 79% H₂, and a steam/CO molar ratio of 15. The superficial velocity SV was 2400 h⁻¹. Prior to the activity evaluation, the catalyst underwent reduction for one hour in flowing H₂ at 450 degrees C.

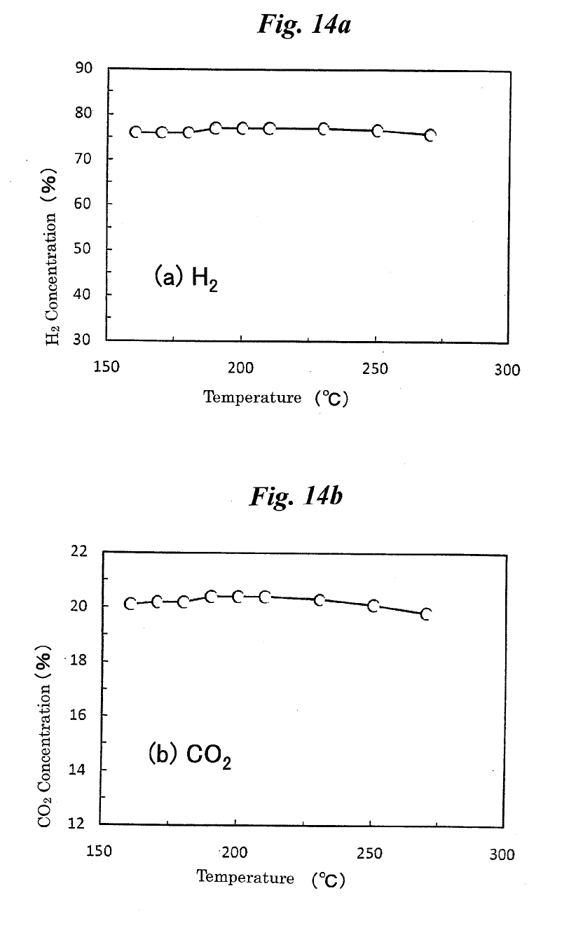

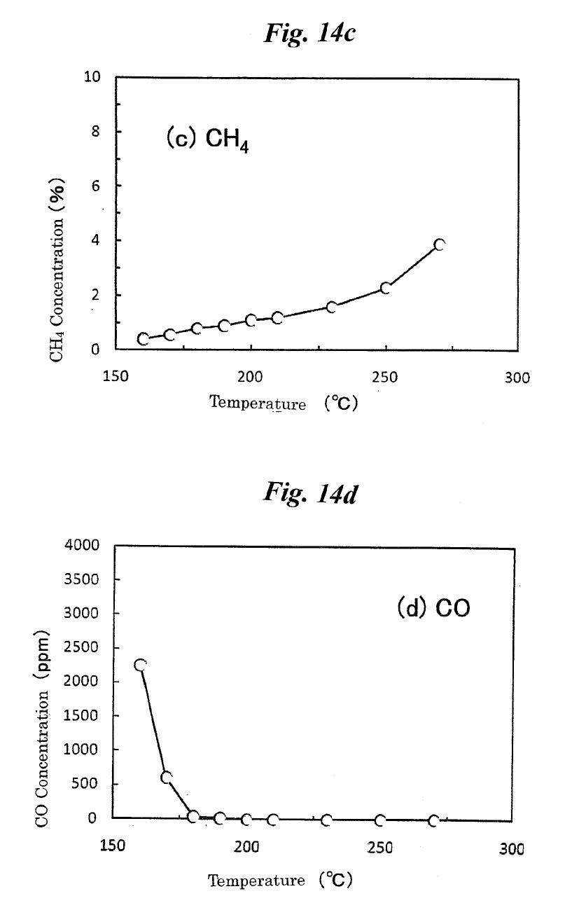

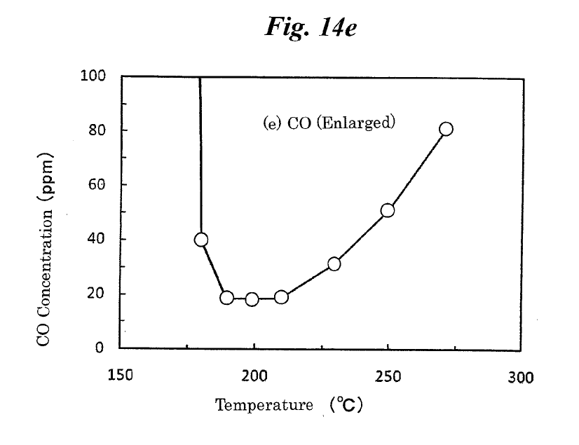

FIGS. 14a to 14e show evaluation results. Although the arrangement that nickel was supported on a single oxide support through impregnation is the same as that in the fifth practical example, the titanium oxide support shows a higher CO methanation activity and an inhibited CO₂ methanation reaction to relatively high temperature. In this practical example, it is also found that CO₂ methanation reaction can be inhibited even if the reaction inhibitor may be added to the support raw material in advance.

### Seventh Practical Example

The FTIR (Fourier Transform Infrared) spectrum of CO and CO₂ adsorption to catalyst powder was measured using a Fourier Transform Infrared Spectrometer (from Thermo Fisher Scientific K.K.) including an ordinary-pressure flowing-type heated diffuse reflector (from ST Japan, Inc.) and an MCT (Mercury Cadmium Telluride) detector. Infrared light was made incident into samples through a barium fluoride window provided in the heated diffuse reflector. In spectral acquisition, the wave number resolution was 4 cm⁻¹ and the cumulated number was 512.

Reaction gases H₂, CO₂, CO, and He were introduced by a mass flow controller into the heated diffuse reflector. A ceramic cup with an inside diameter of 5 mm and a depth of 3 mm was filled with a catalyst powder sample and set in the heated diffuse reflector. Prior to the adsorption experiment, the sample underwent hydrogen reduction. This was for reducing Ni, a catalytic activity component. H₂ reductive gas flowed at 100 ml/min through the heated diffuse reflector to be heated up to 500 degrees C. at 10 degrees C./min and then kept at the temperature for one hour. Next, the gas was exchanged from H₂ to He and cooled down to 230 degrees C. After measuring the background spectrum in flowing He at 230 degrees C., mixed gas of 5% CO and 95% He flowed at 100 ml/min for five minutes and, in turn, He gas flowed at 100 ml/min for five minutes to purge CO gas in gas phase, followed by an infrared absorption spectrum measurement. Next, flowing He gas was heated up to 500 degrees C. at 10 degrees C./min and then kept at the temperature for five minutes, and thereafter cooled down to 230 degrees C. This was for removing CO adsorbed on the catalyst powder. Subsequently, CO₂ adsorption was measured as follows. Mixed gas of 5% CO₂ and 95% He flowed at 100 ml/min for five minutes at 230 degrees C. and, in turn, He gas flowed at 100 ml/min for five minutes to purge CO₂ gas in gas phase, followed by an infrared absorption spectrum measurement.

First, the nickel/aluminum composite oxide prepared in the first practical example underwent reduction for one hour in flowing hydrogen at 700 degrees C. without ruthenium to prepare a methanation catalyst Ni/NiAlxOy as a sample in which fine nickel particles precipitated.

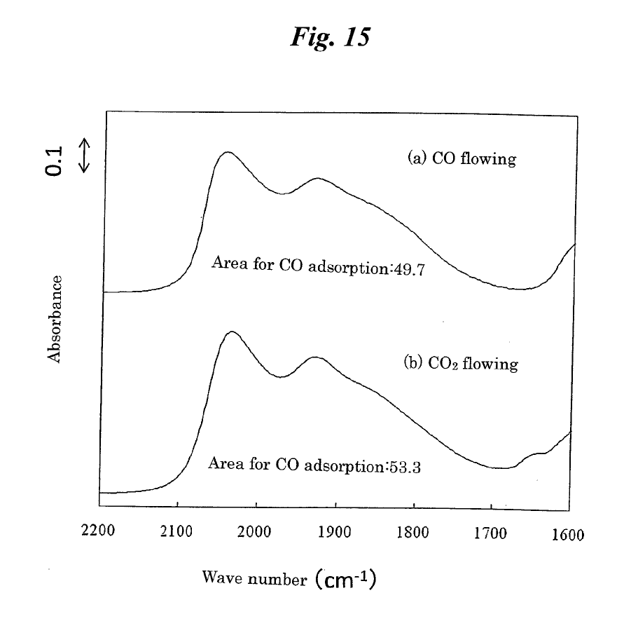

FIG. 15 shows FTIR spectral of CO and CO₂ adsorption obtained for the catalyst. For the cases of CO and CO₂ flowing, the area for linear CO adsorption calculated by integrating the range from 2200 to 1700 cm⁻¹ is noted in the figure. The ratio of the areas is calculated as follows.

(Linear CO area for CO₂ flowing)/(Linear CO area for CO flowing)=53.3/49.7=1.07

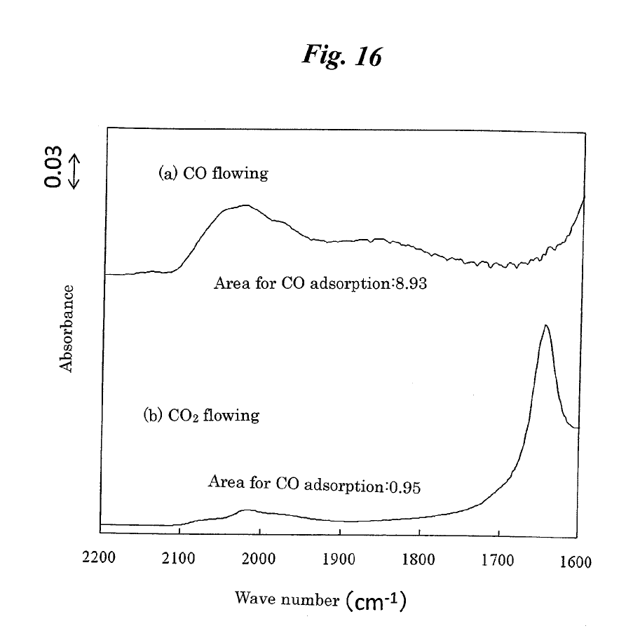

On the other hand, FIG. 16 shows results for the methanation catalyst with a predetermined amount of ammonium chloride added thereto. Compared to FIG. 15, the peak area for CO adsorption is reduced for both the cases of CO and CO₂ flowing as a result of the addition of ammonium chloride, in particular for the case of CO₂ flowing. This indicates that the addition of ammonium chloride as a methanation reaction inhibitor contributes to significant reduction in the generation of adsorbed CO due to desorption of adsorbed CO₂ as indicated by Reaction Formula 5, whereby the production of methane from CO₂ is inhibited.

CO₂(g)→CO₂(a)→CO(a)+O(a) (Reaction Formula 5)

The ratio of the linear CO areas for CO and CO₂ flowing is then calculated as follows. The ratio is about one order of magnitude smaller than that (1.07) in the case no ammonium chloride was added.

(Linear CO area for CO₂ flowing)/(Linear CO area for CO flowing)=0.95/8.93=0.11

Such a variation in the ratio of linear CO areas obtained through FTIR was similarly observed not only on ammonium chloride but also on other reaction inhibitors having an effect of inhibiting CO₂ methanation reaction, the values being generally within the range of 0.01 to 0.15.

### Eighth Practical Example

Methanation reaction inhibitors are believed to be adsorbed to, bonded to, or combines with the surface of an active metal, the interface of a support, and the surface of the support in the vicinity of the active metal to strongly attract electrons. For example, chlorine Cl, one of such methanation reaction inhibitors, is known to have a high electronegativity and therefore a high electron-accepting property. It is expected that chlorine can be adsorbed onto the surface and vicinity of an active metal to attract electrons in the active metal and thereby effect a positive charge (δ+) on the surface of metal particles.

Hence in this practical example, the effect of charges on the surface of Ni, an active metal, on CO₂ adsorption and desorption was calculated through a density-functional approach.

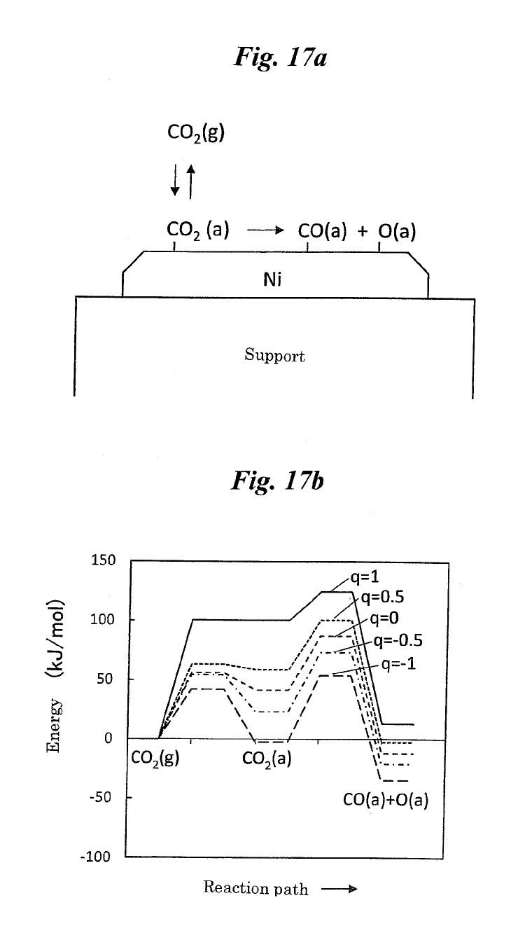

The calculation program used was Material Studio, DMo13 from Accelrys K.K. The Ni Surface model used was a three-dimensional periodic boundary condition model (slab model) including two layers of Ni(111)-(3×3) and using a box with a vacuum of 10 Å from the surface as a unit cell. The number of Ni atoms in a unit cell was 18. Calculations for the reaction scheme shown in FIG. 17a were made using the model. First, a CO₂ molecule was located about 5 Å away from the surface and a structure optimization calculation was made to obtain +CO₂ (g) on the surface of Ni. Similarly, structures in which a CO₂ molecule was located in the vicinity of the surface and a CO molecule and an O atom were located in the vicinity of the surface were optimized to obtain —CO₂ (a) on the surface of Ni and —CO (a) and —O (a) on the surface of Ni, respectively. Next, a transition state between their respective stabilized structures was calculated. For the adsorption process, an energy profile against the Ni—C distance was prepared through a limited structure optimization in which the Ni—C distance was fixed and the highest energy peak was determined as a transition state. Similarly, for the process CO₂→CO+0, the transition state was obtained through a limited structure optimization in which the C—O distance was fixed. These calculations were made for the system charges q=1, 0.5, 0, −0.5, and −1. The followings are detailed calculation options: (1) functional: Revised PBE, (2) basis function: DNP (numerical basis including a polarization function in a split-valence of a double zeta level), (3) pseudo potential: DSPP (Density functional Semi-core Pseudo Potential), (4) thermal smearing=0.01 hartree.

FIG. 17b shows an energy diagram obtained. It is found from the calculation results that CO₂ (a) is destabilized with a positive increase in the charge on the surface. At q=0.5, the activation energy, with which CO₂ (a) is desorbed to be CO (g) in gas phase, is reduced to as low as 10 kJ/mol. At q 1, CO₂ (a) no longer has a stabilized structure, where the reaction path of the adsorption process has a repulsive potential. That is, it is found that the adsorption of CO₂ onto the positively charged surface is inhibited. The threshold value of whether or not CO₂ (a) can exist relatively stably is said to be around 10 kJ/mol in the desorption activation energy.

### Ninth Practical Example

Here will be described an example of concurrently carrying out the steps of forming aluminum oxide as a catalyst support and adding ammonium vanadate as a methanation reaction inhibitor.

First, 0.60 g of ammonium vanadate (NH₄)₂VO₃ was introduced into 61 ml of pure water and heated to be dissolved. On the other hand, 44.1 g of aluminum nitrate was dissolved in 235 ml of pure water. These two solutions were mixed and then transferred to a 2 L beaker, and stirred at 2500 rpm to be added with ammonium carbonate solution by drops in about fifteen minutes such that the solution had a pH of 8, and further the solution was stirred for another thirty minutes. The precipitation was filtered through a membrane filter of 0.2 μm and then rinsed in 1 L of pure water. The resulting precipitation was dried half a day under a low-pressure atmosphere at room temperature and then dried for twelve hours at 110 degrees C. The resulting gel was grinded and pulverized, and then burned for three hours at 900 degrees C. in air to obtain an oxide support with a molar ratio of Al:V=0.96:0.04.

Subsequently, 6.26 g of the oxide support powder Al_{0.96}V_{0.04}Ox was introduced into 50 ml of pure water to prepare a suspension. Next, 7.43 g of nickel nitrate Ni(NO₃)₂.6H₂O (from KANTO CHEMICAL Co., Inc.) was dissolved in 50 ml of pure water. The nickel nitrate solution was added entirely to the suspension of the oxide support using a burette in about twenty minutes with the suspension being stirred. The resulting suspension was stirred for thirty minutes at room temperature and then for thirty minutes in hot water at 45 degrees C., and thereafter once cooled down to room temperature, and then applied to an evaporator in hot water at 35 to 50 degrees C. to evaporate moisture completely. The resulting powder was dried for twelve hours at 110 degrees C. and then burned for three hours at 500 degrees C. to obtain a 20 wt %—Ni/Al_{0.96}V_{0.04}Ox catalyst with Ni supported thereon at 20 wt % in metallic conversion. Similarly, 12.8 g and 29.7 g of nickel nitrate were added to 6.26 g of the oxide support powder according to the same procedure to obtain 30 wt %—Ni/Al_{0.96}V_{0.04}Ox and 50 wt %—Ni/Al_{0.96}V_{0.04}Ox catalysts, respectively.

The three resulting selective CO methanation catalyst powders were applied to a honeycomb according to the above-described procedure and underwent methanation activity evaluations. Prior to the activity evaluations, the catalysts underwent hydrogen reduction for one hour in at 500 degrees C.

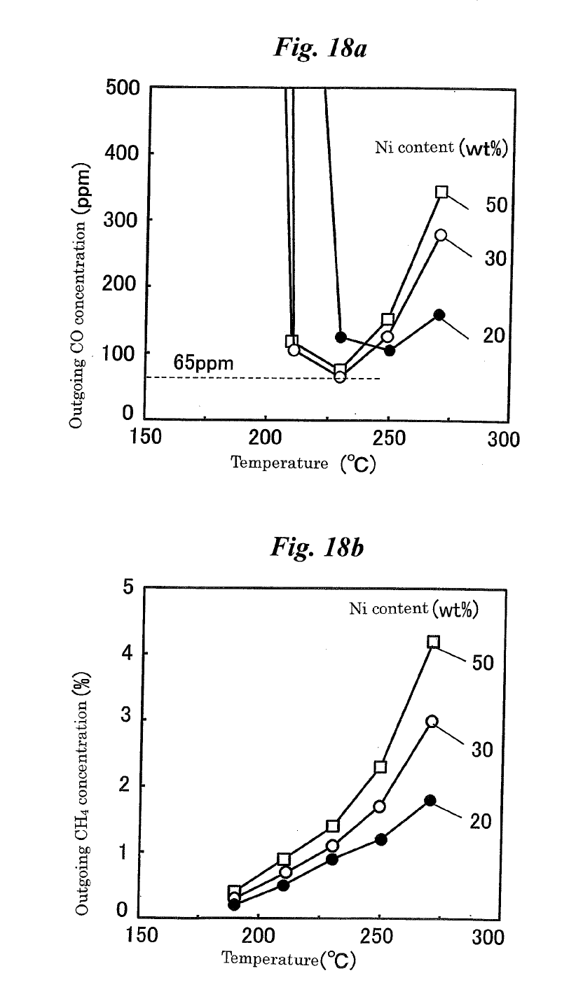

FIGS. 18a and 18b show methanation activity evaluation results of each catalyst. For the Ni support ratios of 30 wt % and 50 wt %, the outgoing concentration of CO is reduced to 65 ppm at the lowest. Meanwhile, for the Ni support ratio of 20 wt %, the outgoing concentration of CO is 100 ppm, but the production of CH₄ from CO₂ is reduced to the lowest level. It is thus found that mixing vanadium during the preparation of the aluminum oxide support exhibits a higher CO₂ methanation inhibiting effect than adding vanadium to the catalyst as described in the fourth practical example. In addition, this catalyst, though no Ru noble metal added thereto, exhibits a ratio of CO removal comparable to that of catalysts with Ru added thereto, having a high selective impact as well as a high economic impact.

### Tenth Practical Example

In the ninth practical example, the aluminum/vanadium molar ratio was Al:V=0.96:0.04. In this practical example will be described an effect when the additive ratio of vanadium is further increased.

First, 1.03 g of ammonium vanadate (NH₄)₂VO₃ was introduced into 100 ml of pure water and heated to be dissolved. On the other hand, 44.1 g of aluminum nitrate was dissolved in 235 ml of pure water. These two solutions were mixed and then transferred to a 2 L beaker, and stirred at 2500 rpm to be added with ammonium carbonate solution by drops in about fifteen minutes such that the solution had a pH of 8, and further the solution was stirred for another thirty minutes. The precipitation was filtered through a membrane filter of 0.2 μm and then rinsed in 1 L of pure water. The resulting precipitation was dried half a day under a low-pressure atmosphere at room temperature and then dried for twelve hours at 110 degrees C. The resulting gel was grinded and pulverized, and then burned for three hours at 900 degrees C. in air to obtain an oxide support with a molar ratio of Al:V=0.93:0.07.

Additionally, 2.56 g of ammonium vanadate (NH₄)₂VO₃ was introduced into 200 ml of pure water and heated to be dissolved. On the other hand, 44.1 g of aluminum nitrate was dissolved in 235 ml of pure water. These two solutions were mixed and then transferred to a 2 L beaker, and stirred at 2500 rpm to be added with ammonium carbonate solution by drops in about fifteen minutes such that the solution had a pH of 8, and further the solution was stirred for another thirty minutes. The precipitation was filtered through a membrane filter of 0.2 μm and then rinsed in 1 L of pure water. The resulting precipitation was dried half a day under a low-pressure atmosphere at room temperature and then dried for twelve hours at 110 degrees C. The resulting gel was grinded and pulverized, and then burned for three hours at 900 degrees C. in air to obtain an oxide support with a molar ratio of Al:V=0.84:0.16.

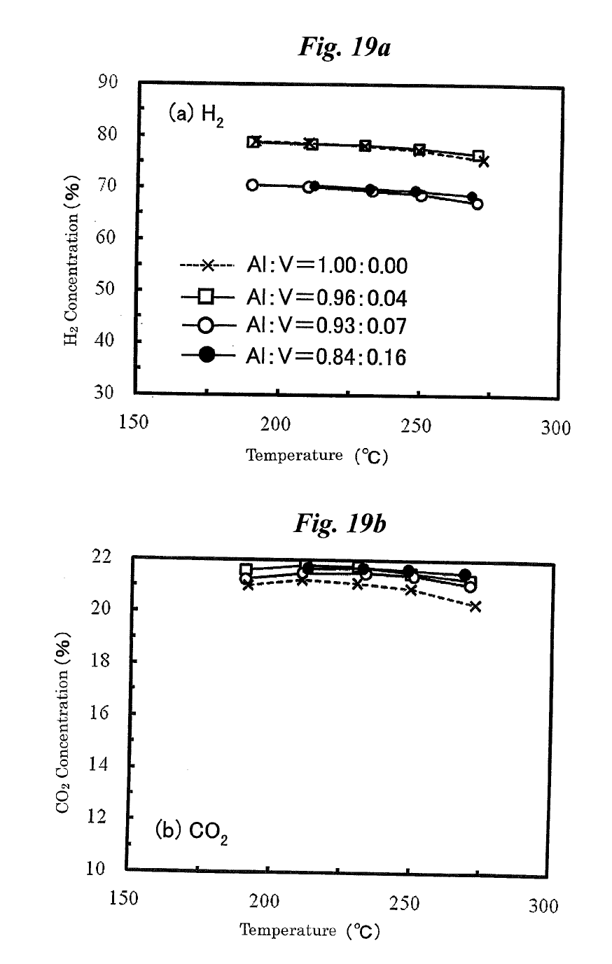

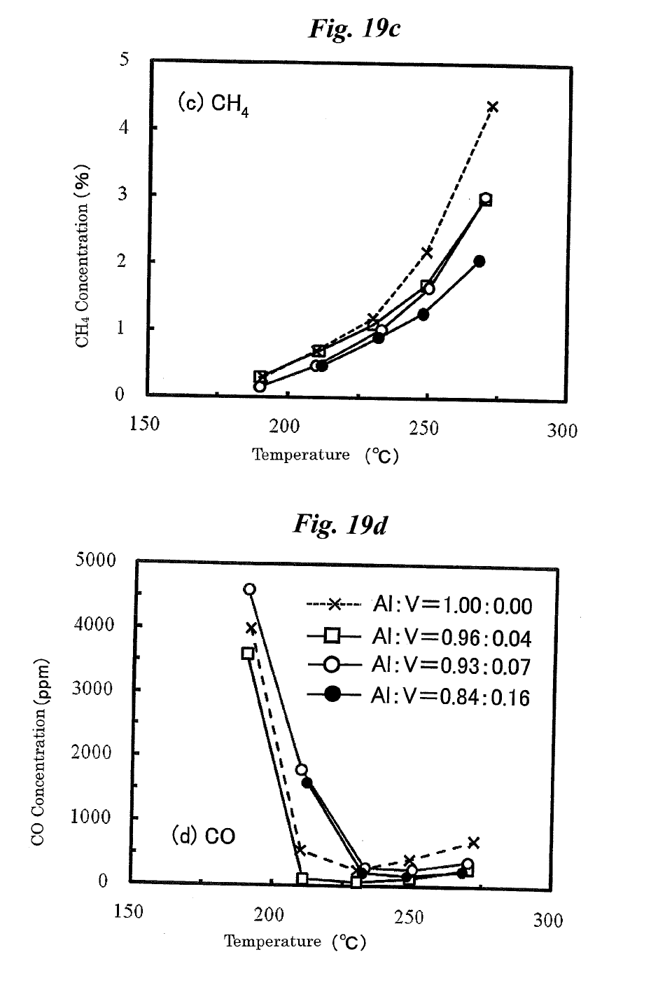

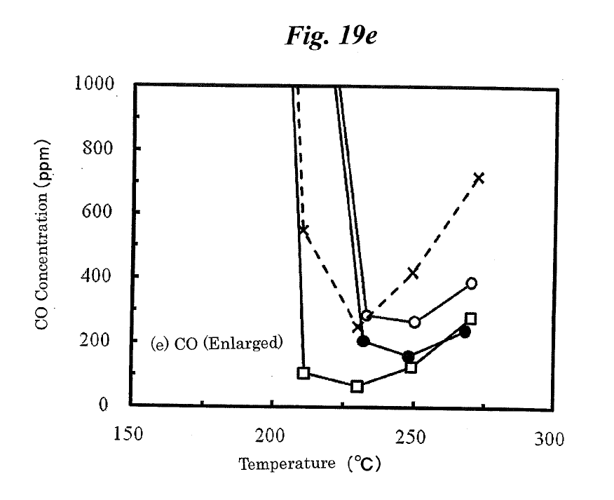

According to the same procedure as described in the ninth practical example, Ni was supported as an active metal on each resulting oxide support, and then the catalysts were each applied to a honeycomb. FIGS. 19a to 19e show methanation activity evaluation results of each catalyst having the same Ni support ratio of 30 wt % but their respective different additive amounts of vanadium. The incoming concentration of CO was 0.8 vol % and also the other conditions were the same as those in the above-described practical examples.

Referring to FIG. 19c, the concentration of CH₄ outgoing from each catalyst indicates the effect of the addition of vanadium on the reaction selectivity. The catalyst with no vanadium added thereto (indicated by the dashed line) shows an increased concentration of produced CH₄ with the increase in the reaction temperature. The outgoing concentration of CH₄ of 1.6% corresponds to the CO selectivity of 50% (i.e. the ratio of CH₄ produced from CO among the whole CH₄ is 50%). This giving an indication of the effect of the inhibitor, the catalyst with no vanadium added thereto shows a reaction selectivity of lower than 50% at higher than 240 degrees C. On the other hand, the catalyst with vanadium added to the support maintains a selectivity of 50% or higher up to 260 degrees C., indicating an effect of vanadium as a CO₂ methanation reaction inhibitor. The effect is most apparent over the additive amount of Al:V=0.84:0.16 (in molar ratio). FIGS. 19d and 19e indicate the effect of vanadium on CO methanation reaction activity. In the high-temperature range of 230 degrees C. or higher, all the catalysts with vanadium added thereto show a significantly reduced outgoing concentration of CO than the catalyst with no vanadium added thereto, indicating a higher effect of removing CO. In the low-temperature range from 210 to 230 degrees C., the effect varies depending on the additive amount of vanadium. The catalyst with the smallest amount of vanadium added thereto at Al:V=0.96:0.04 exhibits a highest effect of removing CO.

### Eleventh Practical Example

Here will be described an example of concurrently carrying out the steps of adding nickel as an active metal and adding ammonium vanadate as a methanation reaction inhibitor to γ-alumina serving as a catalyst support.

First, 5.00 g of alumina powder was introduced into 50 mL of pure water to prepare a suspension. Next, 6.19 g of nickel nitrate Ni(NO₃)₂.6H₂O (from KANTO CHEMICAL Co., Inc.) was dissolved in 50 mL of pure water. Further, 0.50 g of ammonium vanadate (NH₄)₂VO₃ (from KANTO CHEMICAL Co., Inc.) was introduced into 50 mL of pure water and heated to be dissolved. These two solutions were mixed completely and added entirely to the suspension of γ-alumina using a burette in about twenty minutes with the suspension being stirred. The resulting suspension was stirred for thirty minutes at room temperature and then for thirty minutes in hot water at 45 degrees C., and thereafter once cooled down to room temperature, and then applied to an evaporator in hot water at 35 to 50 degrees C. to evaporate moisture completely. The resulting powder was dried for twelve hours at 110 degrees C. and then burned for three hours at 500 degrees C. to obtain a 20 wt %—Ni—V/Al₂O₃ catalyst with Ni at 20 wt % in metallic conversion and vanadium at a V/Ni molar ratio of 0.2 supported thereon.

According to the above-described procedure, the resulting selective CO methanation catalyst powder was applied to a honeycomb and underwent a methanation activity evaluation. Prior to the activity evaluation, the catalyst underwent hydrogen reduction for one hour at 500 degrees C.

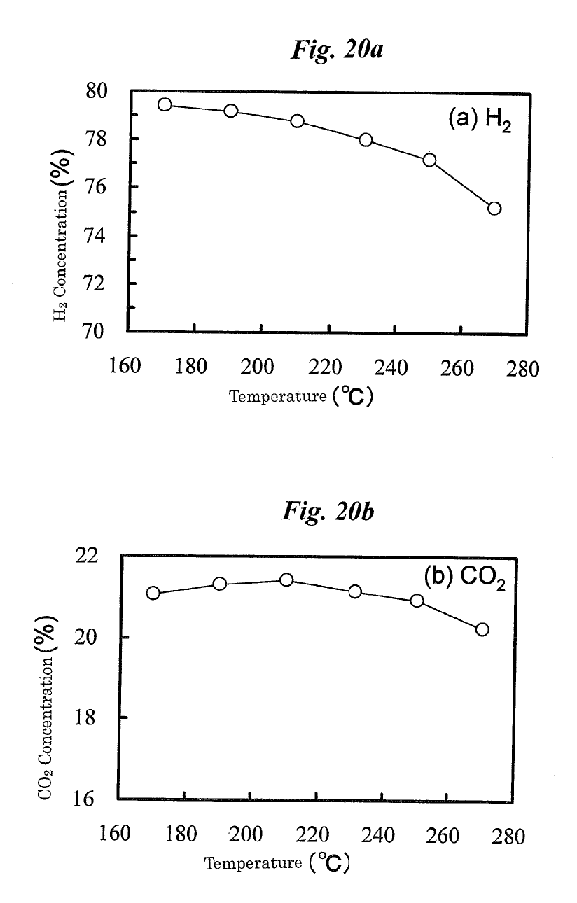

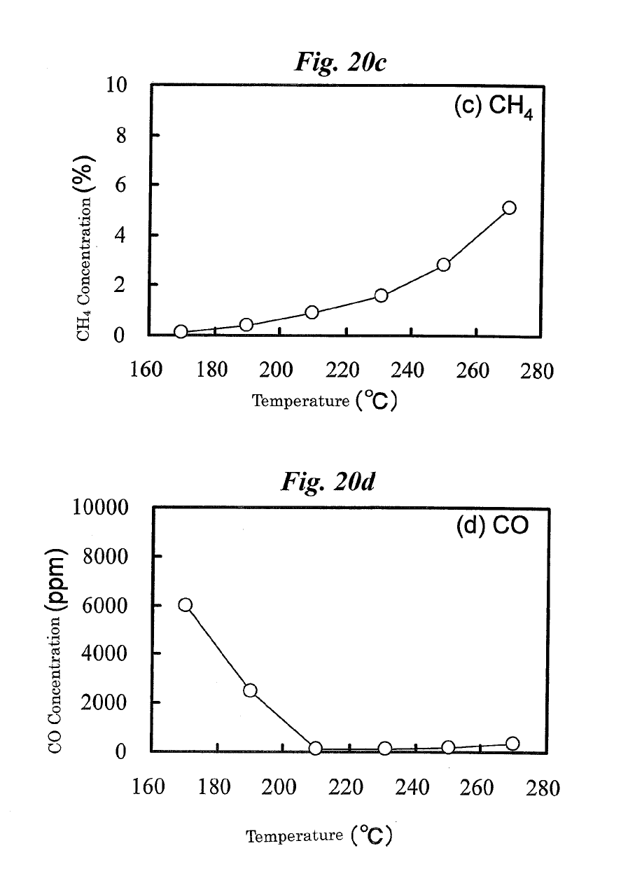

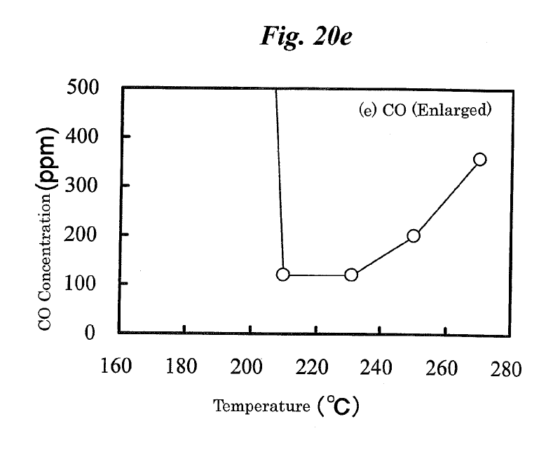

FIGS. 20a to 20e show methanation activity evaluation results of the catalyst. Although the catalyst with no vanadium added thereto but Nickel only supported thereon shows an outgoing concentration of CO of 250 ppm at lowest as described in the tenth practical example, this catalyst, to which vanadium and nickel were added concurrently, shows a significantly reduced outgoing concentration of CO of as low as 120 ppm, indicating a new effect of vanadium. On the other hand, the amount of methane production hardly differs from that of the catalyst containing no vanadium. The reason is currently not known exactly why the vanadium-added catalyst prepared according to this procedure does not inhibit CO₂ methanation reaction but promote CO methanation reaction. It was however observed in an X-ray diffraction pattern of this catalyst that Ni and V formed alloy. There is a possibility that the alloy formation inhibits the true effect of vanadium.

### Twelfth Practical Example

This practical example describes a method for preparing a selective CO methanation catalyst according to the present invention using not ammonium vanadate but ammonium molybdate as a reaction inhibitor, and also describes an effect of the method.

First, 5.00 g of the nickel/aluminum composite oxide powder in the comparative example was suspended in 25 mL of pure water. Next, 0.3111 g of ammonium molybdate tetrahydrate (from KANTO CHEMICAL Co., Inc.) was dissolved completely in 20 mL of pure water, and then the solution was added by drops in five minutes to the suspension of the composite oxide powder using a burette. The resulting suspension was stirred for thirty minutes at room temperature, and then transferred to an eggplant-shaped flask and stirred for one hour at 45 degrees C., and thereafter cooled down to degrees C. to distil away the solvent under a low-pressure atmosphere. The resulting solid was dried for twelve hours at 110 degrees C. and then burned for three hours in air at 500 degrees C. in an electric furnace to obtain catalyst powder with molybdenum at 4.83 wt % in MoO₃ conversion.

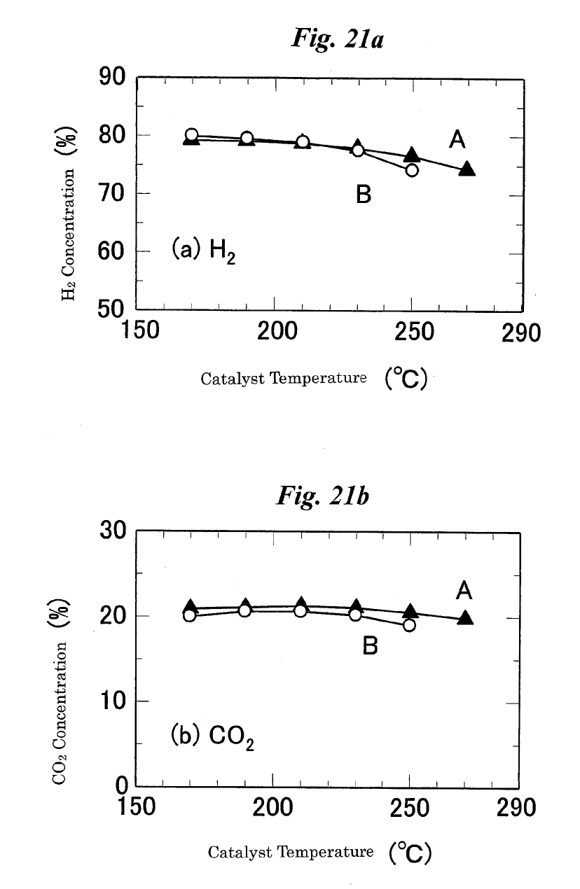

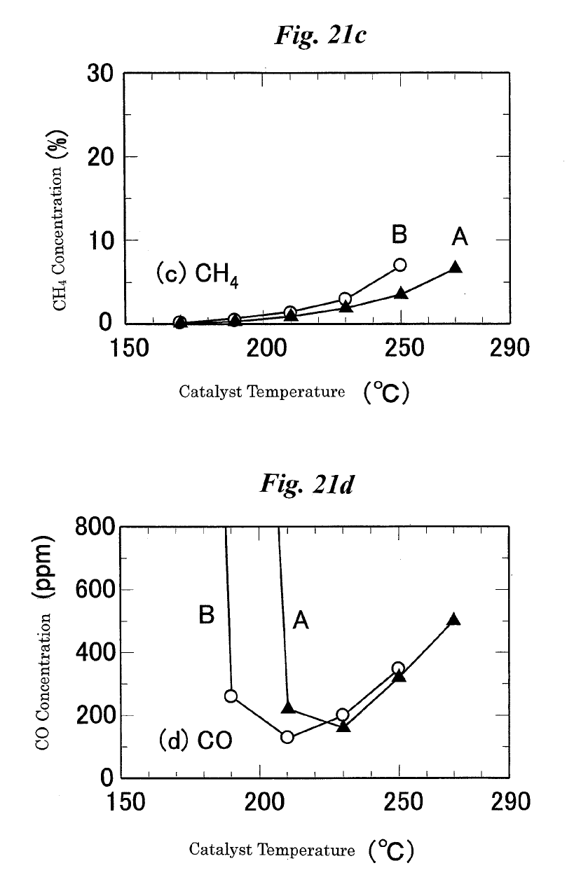

According to the same procedure as described above, the resulting selective CO methanation catalyst powder was applied to a honeycomb and underwent a methanation activity evaluation. Prior to the activity evaluation, the catalyst underwent hydrogen reduction for one hour at 700 degrees C. FIGS. 21a to 21d show evaluation results. The catalyst with no ammonium molybdate added thereto is indicated by plot A, while the catalyst with ammonium molybdate added thereto is indicated by plot B.

With ammonium vanadate added, the temperature dependence curves of the outgoing concentration of CO and CH₄ both shift toward the high-temperature side, in particular of CH₄, as mentioned above. In this practical example, the CO and CH₄ concentration curves with ammonium molybdate added both shift toward the low-temperature side, compared to the catalyst with no ammonium molybdate added thereto. It seems that the catalyst has no effect of inhibiting CO₂ methanation reaction, unlike the case of vanadium. It is however clear, from close examination of the temperature by which the curves shift toward the low-temperature side, that the catalyst has an effect of inhibiting CO₂ methanation reaction. That is, the point of the maximum ratio of CO removal shifts toward the low-temperature side by about 20 degrees C. as a result of adding molybdic acid, while the point at which the reaction selectivity is 50% (CH₄ concentration is 2%) shifts only by about 12 degrees C. Although the reason is currently not known why the addition of ammonium molybdate increases CO methanation activity at low temperature, it can be said that the shift amount of the CH₄ concentration curve being smaller than that of the CO curve clearly shows CO₂ methanation reaction being inhibited.

### INDUSTRIAL APPLICABILITY

As described heretofore in detail, the present invention is directed to a method for selectively transforming carbon monoxide CO into methane CH₄, a catalyst for use in such a method, and a process for producing such a catalyst. Applying the catalyst material to a reactor allows hydrogen rich gas with a CO concentration of 10 ppm or less to be produced stably from mixed gas containing CO₂, CO, and H₂. A catalyst used therefor can be produced at low cost and CO is removed with H₂ existing in gas, thereby requiring no air to be supplied, unlike conventional systems, and therefore a large air pump and a flow rate regulator, which are indispensable with conventional selective CO oxidation catalysts, resulting in a significant reduction in the system cost. The present invention is applicable and useful as, for example, catalysts for fuel reformers for use in home-use polymer electrolyte fuel cell power generation systems and onsite hydrogen stations for fuel cell vehicles as well as hydrogen purifying catalysts for use in chemical plants. The present invention also provides a fuel reformer utilizing such a catalyst.

What is claimed is:

1. A fuel reformer for producing hydrogen gas from a hydrocarbon fuel for supply to a fuel cell, comprising a selective CO methanation reactor for selectively transforming carbon monoxide in hydrogen gas under reformation containing carbon monoxide and carbon dioxide into methane, wherein;
the selective CO methanation reactor includes a catalyst for selectively transforming carbon monoxide into methane, and wherein;
the catalyst includes an oxide support with at least one of a noble metal and a transition metal supported thereon as an active component, and at least one of a halogen (excluding chlorine from chloride of the active metal), an inorganic acid (excluding hydrochloric acid, sulfuric acid, and nitric acid from inorganic acid salt of the active metal), and a metal oxo-acid (excluding molybdic acid, tungstic acid, perrhenic acid, and platinic acid), and a precursor, a reactant, and a decomposition product thereof adsorbed or bonded thereto as a carbon dioxide methanation reaction inhibitor.

2. A fuel reformer for producing hydrogen gas from a hydrocarbon fuel for supply to a fuel cell, comprising a selective CO methanation reactor for selectively transforming carbon monoxide in hydrogen gas under reformation containing carbon monoxide and carbon dioxide into methane, wherein;
the selective CO methanation reactor includes a catalyst for selectively transforming carbon monoxide into methane, and wherein;
the catalyst includes an oxide support with at least one of a noble metal and a transition metal supported thereon as an active component, and at least one of a halogen, an inorganic acid, and a metal oxo-acid, and a precursor, a reactant, and a decomposition product thereof adsorbed or bonded thereto as a carbon dioxide methanation reaction inhibitor,
the fuel reformer further comprising an apparatus for supplying gas or solution containing the methanation reaction inhibitor to the selective CO methanation reactor.

3. In a fuel reformation process for producing hydrogen gas from a hydrocarbon fuel for supply to a fuel cell,
a method for selectively transforming carbon monoxide in hydrogen gas under reformation containing carbon monoxide and carbon dioxide into methane by bringing the carbon monoxide into contact with a catalyst, wherein;
the catalyst includes an oxide support with at least one of a noble metal and a transition metal supported thereon as an active component, and at least one of a halogen (excluding chlorine from chloride of the active metal), an inorganic acid (excluding hydrochloric acid, sulfuric acid, and nitric acid from inorganic acid salt of the active metal), and a metal oxo-acid (excluding molybdic acid, tungstic acid, perrhenic acid, and platinic acid), and a precursor, a reactant, and a decomposition product thereof adsorbed or bonded thereto as a carbon dioxide methanation reaction inhibitor.

4. In a fuel reformation process for producing hydrogen gas from a hydrocarbon fuel for supply to a fuel cell,
a method for selectively transforming carbon monoxide in hydrogen gas under reformation containing carbon monoxide and carbon dioxide into methane by bringing the carbon monoxide into contact with a catalyst, wherein;
the catalyst includes an oxide support with at least one of a noble metal and a transition metal supported thereon as an active component, and at least one of a halogen, an inorganic acid, and a metal oxo-acid, and a precursor, a reactant, and a decomposition product thereof adsorbed or bonded thereto as a carbon dioxide methanation reaction inhibitor,
the method comprising supplying gas or solution containing the methanation reaction inhibitor to the catalyst.

5. A catalyst for selectively transforming carbon monoxide in hydrogen gas containing carbon monoxide and carbon dioxide into methane, comprising an oxide support with at least one of a noble metal and a transition metal supported thereon as an active component, and at least one of a halogen (excluding chlorine from chloride of the active metal), an inorganic acid (excluding hydrochloric acid, sulfuric acid, and nitric acid from inorganic acid salt of the active metal), and a metal oxo-acid (excluding molybdic acid, tungstic acid, perrhenic acid, and platinic acid), and a precursor, a reactant, and a decomposition product thereof adsorbed or bonded thereto as a carbon dioxide methanation reaction inhibitor.

6. The selective CO methanation catalyst according to claim 5, wherein the active component is at least one selected from the group consisting of nickel, ruthenium, and platinum.

7. The selective CO methanation catalyst according to claim 5, wherein the oxide support contains at least one selected from the group consisting of nickel, aluminum, titanium, silicon, zirconium, and cerium.

8. A fuel reformer for producing hydrogen gas from a hydrocarbon fuel for supply to a fuel cell, comprising a selective CO methanation reactor for selectively transforming carbon monoxide in hydrogen gas under reformation containing carbon monoxide and carbon dioxide into methane, wherein;
the selective CO methanation reactor includes a catalyst for selectively transforming carbon monoxide into methane, and wherein;
the catalyst includes an oxide support with at least one of a noble metal and a transition metal supported thereon as an active component, and at least one of fluorine, bromine, iodine, phosphoric acid, boric acid, vanadium acid, and chromic acid, and a precursor, a reactant, and a decomposition product thereof adsorbed or bonded thereto as a carbon dioxide methanation reaction inhibitor.

9. The selective CO methanation catalyst according to claim 5, wherein carbon dioxide adsorbed on the surface of a metal selected as the active component has a desorption activation energy of 10 kJ/mol or lower.

10. The selective CO methanation catalyst according to claim 5, wherein given that the linear CO adsorption-equivalent peak area for CO adsorption through a Fourier transform infrared spectroscopy of the catalyst is 1.0, the linear CO adsorption-equivalent peak area for CO₂ adsorption is 0.01 to 0.15.

11. A process for producing a selective CO methanation catalyst comprising the steps of producing an oxide support, adding a catalyst active component, and adding at least one of a halogen (excluding chlorine from chloride of the active metal), an inorganic acid (excluding hydrochloric acid, sulfuric acid, and nitric acid from inorganic acid salt of the active metal), and a metal oxo-acid (excluding molybdic acid, tungstic acid, perrhenic acid, and platinic acid), and a precursor, a reactant, and a decomposition product thereof as a carbon dioxide methanation reaction inhibitor.

12. A process for producing a selective CO methanation catalyst comprising the steps of producing an oxide support, adding a catalyst active component, and adding at least one of a halogen, an inorganic acid, and a metal oxo-acid, and a precursor, a reactant, and a decomposition product thereof as a carbon dioxide methanation reaction inhibitor, wherein;
the steps of producing an oxide support and adding a carbon dioxide methanation reaction inhibitor are carried out concurrently by using a coprecipitation technique to precipitate the oxide support and the methanation reaction inhibitor from solution with raw salts for the oxide support and the methanation reaction inhibitor dissolved therein.

13. A catalyst for selectively transforming carbon monoxide in hydrogen gas containing carbon monoxide and carbon dioxide into methane, comprising an oxide support with at least one of a noble metal and a transition metal supported thereon as an active component, and at least one of a halogen (excluding chlorine), an inorganic acid (excluding hydrochloric acid, sulfuric acid, and nitric acid), and a metal oxo-acid (excluding molybdic acid, tungstic acid, perrhenic acid, and platinic acid), and a precursor, a reactant, and a decomposition product thereof adsorbed or bonded thereto as a carbon dioxide methanation reaction inhibitor.

14. A fuel reformer for producing hydrogen gas from a hydrocarbon fuel for supply to a fuel cell, comprising a selective CO methanation reactor for selectively transforming carbon monoxide in hydrogen gas under reformation containing carbon monoxide and carbon dioxide into methane, wherein;
the selective CO methanation reactor includes a catalyst for selectively transforming carbon monoxide into methane, and wherein;
the catalyst includes an oxide support with at least one of a noble metal and a transition metal supported thereon as an active component, and vanadium acid or a precursor, a reactant, or a decomposition product thereof adsorbed or bonded thereto as a carbon dioxide methanation reaction inhibitor.

15. A catalyst for selectively transforming carbon monoxide in hydrogen gas containing carbon monoxide and carbon dioxide into methane, comprising an oxide support with at least one of a noble metal and a transition metal supported thereon as an active component, and vanadium acid or a precursor, a reactant, or a decomposition product thereof adsorbed or bonded thereto as a carbon dioxide methanation reaction inhibitor.

16. A process for producing a selective CO methanation catalyst comprising the steps of producing an oxide support, adding a catalyst active component, and adding chlorine as a carbon dioxide methanation reaction inhibitor at a ratio equal to or higher than 0.2 weight % but equal to or lower than 1.0 weight % to the total amount of the oxide support and the catalyst active component.

17. In a fuel reformation process for producing hydrogen gas from a hydrocarbon fuel for supply to a fuel cell,
a method for selectively transforming carbon monoxide in hydrogen gas under reformation containing carbon monoxide and carbon dioxide into methane at a high reaction temperature of higher than 225 degrees C. by bringing the carbon monoxide into contact with a catalyst, wherein;
the catalyst includes an oxide support with at least one of a noble metal and a transition metal supported thereon as an active component, and at least one of a halogen, an inorganic acid, and a metal oxo-acid, and a precursor, a reactant, and a decomposition product thereof adsorbed or bonded thereto as a carbon dioxide methanation reaction inhibitor.
